(19) United States
(12) Patent Application Publication
(10) Pub. No.: US 2024/0265681 A1
(43) Pub. Date: Aug. 8, 2024

(54) SYSTEM AND METHOD FOR DATA HARVESTING FROM ROBOTIC OPERATIONS FOR CONTINUOUS LEARNING OF AUTONOMOUS ROBOTIC MODELS

(71) Applicants: Andrés Felipe Chavez Cortes, El Cerrito, CA (US); Carlos Andres Alvarez Restrepo, Medellín (CO); Rafael Rincon, Medellín (CO); Camilo Cabrera, Neiva (CO)

(72) Inventors: Andrés Felipe Chavez Cortes, El Cerrito, CA (US); Carlos Andres Alvarez Restrepo, Medellín (CO); Rafael Rincon, Medellín (CO); Camilo Cabrera, Neiva (CO)

(21) Appl. No.: 18/435,855

(22) Filed: Feb. 7, 2024

Related U.S. Application Data
(60) Provisional application No. 63/483,707, filed on Feb. 7, 2023.

(51) Int. Cl. G06V 10/774; G05D 1/228; G06V 10/26; G06V 10/82

(52) U.S. Cl. CPC G06V 10/774; G05D 1/228; G06V 10/26; G06V 10/82

(57) ABSTRACT

A system and method involves detecting a trigger event during operation of an autonomous ground vehicle traveling between two physical locations; generating event sequence data from primary sensor data, secondary sensor data, spatiotemporal data, and telemetry data through operation of a reporter; communicating the event sequence data to cloud storage and raw data to a streaming database; transforming the raw data into normalized data stored in a relational database through operation of a normalizer; operating a curation system to identify true trigger events from the normalized data and extract training data by way of a discriminator; operating a machine learning model within an active learning pipeline to generate a model update from aggregate training data generated from the training data by an aggregator; and reconfiguring the navigational control system with the model update communicated from the active learning pipeline to the autonomous ground vehicle.

### CROSS-REFERENCE TO RELATED APPLICATIONS

This application claims priority to provisional patent 63/483,707 filed on Feb. 7, 2023

### BACKGROUND

Adoption of autonomous features in robotic platforms represents one of the most important challenges for the robotic industry. Despite Robots becoming a mainstream tool in society, people are still reluctant to autonomous functions due to fear of malfunction or potential accidents involving bystanders. It is because of this reason that new methods and approaches must be developed to analyze the factors preventing robotic platforms from achieving higher autonomy levels and leverage this data related to expected or unexpected operations to improve existing systems and enable improved autonomy.

Furthermore, autonomous capabilities are imperative to robotic platforms due to how remote operations can always incur a potential collision with an object or bystanders. This may be the result of a mistake by a human operator, or simply a drop in connection due to poor mobile network infrastructure.

Existing inventions related to data collection during instances of robotic operations, for active learning purposes, limit themselves to the collection of data uniquely with the aim of fixing flaws in robotic platforms and preventing potential shortcomings that may limit the ability of the Robot to perform commercial tasks. The present system makes use of this data for this purpose, not only from shortcomings but also relating general events to everyday functions, but to also integrate it into an existing pipeline where it can be analyzed by data engineers and used to train models for autonomous navigation of mobile Robots. The inputs necessary for this data are automatically collected, in order to be curated later on to train a new model to be deployed, or automatically in order to compile a list of events related to robotic operations. The inputs might be collected by a human operator.

Convolutional neural networks (CNNs) are particularly well suited to classifying features in data sets modeled in two or three dimensions. This makes CNNs popular for image classification, because images can be represented in computer memories in three dimensions (two dimensions for width and height, and a third dimension for pixel features like color components and intensity). For example, a color JEG image of size 480×480 pixels can be modelled in computer memory using an array that is 480×480×3, where each of the values of the third dimension is a red, green, or blue color component intensity for the pixel ranging from 0 to 255. Inputting this array of numbers to a trained CNN will generate outputs that describe the probability of the image being a certain class (0.80 for cat, 0.15 for dog, 0.05 for bird, etc.). Image classification is the task of taking an input image and outputting a class (a cat, dog, etc.) or a probability of classes that best describes the image.

Fundamentally, CNNs input the data set, pass it through a series of convolutional transformations, nonlinear activation functions (e.g., RELU), and pooling operations (downsampling, e.g., maxpool), and an output layer (e.g., softmax) to generate the classifications.

### BRIEF SUMMARY

It is the object of the present invention to provide mobile Robots with a reactive system for data collection in case of a robotic breakdown, which may be related to a fall or a crash, as well as a method for leveraging this data to improve robotic navigation capabilities. Further, this system may also collect data pertaining to internal conditions of the robotic platform automatically while performing conventional tasks.

These data inputs can be automatically collected by the robotic platform at the time of the event. This data is hosted in a cloud server where it can be accessed to evaluate trends causing robotic malfunctions. A web interface has been designed to accommodate the data and to offer the visualization of any data videos gathered by the robotic system showing the previous 10 seconds before the malfunction occurred as well as other information measured by a plurality of sensors associated with operation and function of the robotic platform.

The data portrayed in the graphic user interface may be segmented according to the needs of the user, including the navigation mode at the time of the incident, the Robot's current version, and the date range for the incidents, among other type of events related to robotic functions. Further, this interface agglomerates the total number of incidents and triggering actions within a date range to display the number of events by type, as well as the total amount of Robots operating during this timeframe. Trends analyzed under this data scope enable users to discern which robotic versions are struggling the most and what kind of specific incidents are prone to occur in certain models. The data shown in this interface is automatically by an algorithm capable of detecting false positives which may skew the data and the trends shown in the graphics. Localization details included in these reports can help secondary systems detect high-risk areas where mobile Robots are prone to encounter failures and instruct the mobile Robot to avoid these areas autonomously when navigating from one point to another.

Further, the present invention also portrays a method by which the processed data is automatically integrated into a training system for perception models needed for semi-autonomous or fully autonomous navigation. This process may be done manually or automatically by a machine learning algorithm capable of identifying relevant improvement opportunities.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram of system 100 in accordance with one embodiment.

FIG. 2 illustrates a method 200 in accordance with one embodiment.

FIG. 3 illustrates a method 300 in accordance with one embodiment.

FIG. 4 illustrates a method 400 in accordance with one embodiment.

FIG. 5 illustrates a diagram of a system 500 in accordance with one embodiment.

FIG. 6 illustrates an aspect of the subject matter in accordance with one embodiment.

FIG. 7 illustrates a comparison of segmentation accuracy (mIoU) and inference speed (FPS) on the Cityscapes test set.

FIG. 8 illustrates an architecture overview of a semantic learning model.

FIG. 9 illustrates a conventional encoder-decoder in which the decoder keeps the features channels the same and an encoder and proposed Flexible and Lightweight Decoder (FLD).

FIG. 10 illustrates a framework of Unified Attention Fusion Module (UAFM), a Spatial Attention Module, and a Channel Attention Module.

FIG. 11 illustrates a Simple Pyramid Pooling Module (SPPM).

FIG. 12 illustrates a qualitative comparison on the Cityscapes validation set.

FIG. 13 illustrates a comparison between image classification, object detection, and instance segmentation.

FIG. 14 illustrates a Region-based Convolution Network 1400.

FIG. 15 illustrates a Fast Region-based Convolutional Network 1500.

FIG. 16 illustrates a Faster Region-based Convolutional Network 1500.

FIG. 17 illustrates a simplified system 1700 in which a server 1704 and a client device 1706 are communicatively coupled via a network 1702.

FIG. 18 is an example block diagram of a computing device 1800 that may incorporate embodiments of the present invention.

FIG. 19 illustrates a system 1900 in accordance with one embodiment.

### DETAILED DESCRIPTION

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to or combined, without limiting the scope to the embodiments disclosed herein.

In an embodiment, the system and method for data harvesting from robotic operations for continuous learning of autonomous robotic models may involve a method comprising detecting a trigger event during operation of an autonomous ground vehicle traveling between two physical locations, wherein the autonomous ground vehicle comprises primary sensors, secondary sensors, a location module, a navigational control system, a communication module, and movement systems. The method generates event sequence data from primary sensor data, secondary sensor data, spatiotemporal data, and telemetry data through operation of a reporter. The method communicates the event sequence data to cloud storage and raw data to a streaming database. The method transforms the raw data into normalized data stored in a relational database through operation of a normalizer. The method operates a curation system to identify true trigger events from the normalized data and extract training data by way of a discriminator. The method operates a machine learning model within an active learning pipeline to generate a model update from aggregate training data generated from the training data by an aggregator. The method reconfigures the navigational control system with the model update communicated from the active learning pipeline to the autonomous ground vehicle.

In an embodiment, the method further comprises configuring an event handler with event triggers. The method operates the navigational control system comprising an image recognition model, a controller, and the event handler, to receive: the primary sensor data from the primary sensors, the spatiotemporal data from the location module, the secondary sensor data from the secondary sensors, and the telemetry data from the movement systems. The method controls the movement systems through operation of the controller and the image recognition model to transport the autonomous ground vehicle between two physical locations. The method communicates the raw data comprising the primary sensor data, the secondary sensor data, the spatiotemporal data, and the telemetry data to the streaming database by way of the communication module. And the method operates the event handler to monitor the primary sensor data, the secondary sensor data, the spatiotemporal data, and the telemetry data for the event triggers.

In an embodiment, the raw data may comprise at least the telemetry data and the secondary sensor data as a light weight alternative to the full data stream from the autonomous ground vehicle. The telemetry data and the secondary sensor data could be utilized as a sufficient data points in some instances to normalize data from the cloud storage for the relational database.

In an embodiment, the raw data may comprise at least the telemetry data, the secondary sensor data, and the spatiotemporal data as a light weight alternative to the full data stream from the autonomous ground vehicle. The telemetry data, the secondary sensor data, and the spatiotemporal data could be utilized as a sufficient data points in some instances to normalize data from the cloud storage for the relational database.

In an embodiment, the primary sensor data from primary sensors may be converted to event sequence data which are uploaded to cloud storage. The secondary sensor data from secondary sensors and telemetry data from the movement system may then be directly ingested into the streaming database.

In an embodiment, the method further comprises configuring the normalizer with the event sequence data to transform the raw data into the normalized data.

In an embodiment, the method further comprises communicating the raw data to the curation system from the streaming database. The method operates the discriminator to identify at least one trigger event in the raw data. The method triggers the reporter to generate the event sequence data.

In an embodiment, the training data comprises image data collected by the primary sensors during operation of the autonomous ground vehicle during the trigger event.

In an embodiment, the image data may include a point cloud from a 3D LiDAR sensor. The point cloud is a set of data points in 3D space, representing the locations where the sensor's laser beams reflected off objects. This collection of points forms a detailed 3D map of the surrounding environment.

In an embodiment, the discriminator may be configured by way of a user interface to identify the true trigger events from false positives.

In an embodiment, the machine learning model and the image recognition model may be semantic segmentation models.

In an embodiment, the system and method for data harvesting from robotic operations for continuous learning of autonomous robotic models may collect and transmit video footage and metadata related to a Robot, e.g., autonomous ground vehicle, or the environmental information such as GPS position, sensor status, Robot's odometry, sidewalk inclination, available sidewalk segmentation, Robot model, and any other ML model predictions, among others. It also allows data transmission to a cloud server to be analyzed by a human operator and leveraged to improve semi-autonomous navigation operation and/or automated systems for mobile Robots. The present invention also portrays a method by which the processed data is automatically integrated into a training system for perception models needed for semi-autonomous or fully autonomous navigation. This process may be done manually or automatically by a machine learning algorithm capable of identifying relevant improvement opportunities. The system is configured to collect data related to the structural conditions of the robotic platform and the surrounding environment at the time of a collision, fall, malfunction or expected or not expected condition that may trigger an activation function of the system.

In an embodiment, the relevant data may be processed into a graphical user interface (GUI) designed to show trends related to robotic operations by different segments portraying which areas should be improved upon. Once an incident and/or a malfunction occurs related to the functions of the mobile Robot, a data stream structured under an avro schema is sent to a remote cloud server. This report includes relevant data such as the state of the sensors, localization details, video footage depicting the 10 seconds before the incident and the speed of the mobile Robot at the time of the incident and/or malfunction. Furthermore, a report may also be compiled automatically while the mobile Robot is performing different conventional tasks.

In an embodiment, the data collection inside the Robot includes all data sources such as cameras, location with GPS, different sensor sources (ultrasonic, lidar, etc.), and telemetry of the Robot (velocity, internal states, etc.,). The triggering of the event system may occur based on different scenarios such as an accident (automatically detected or by a supervisor), a malfunction of some perception model or the autonomy stack, such as the controller, and/or triggered manually by a curation system. The main process that has in-memory a buffer of the last 10 seconds of data of each data source. This process is also in charge of transforming the data according to the nature of each one. For example, multiple images are converted into videos, sensor data is formatted as a sequence to match the video, etc. It may also upload that data to cloud storage for high bandwidth data types like camera videos and point-cloud sequences. It may then uses a real-time streaming provider to send the metadata of the event and all other sensor data to a real-time database. A real-time system database may include cloud storage to store the videos/point clouds regarding the events. It may also store the raw data of the events in a real-time database. An extract, transfer, load (ETL) process may run on a repetitive time basis to connect to the cloud storage and transform the raw data into a relational database that can be consulted easily later.

In an embodiment the system may also implement different web GUIs and systems to see and interact with the data. These may include a curation and exploration GUI to see and check the events with the sensors all aggregate. This may be used to inspect the events and to curate some false positives. It may also include GUIs that provide different data dashboards of analytics of the events. In an embodiment, the system may include active learning pipelines that use the data to continuously train perception models with failure scenarios.

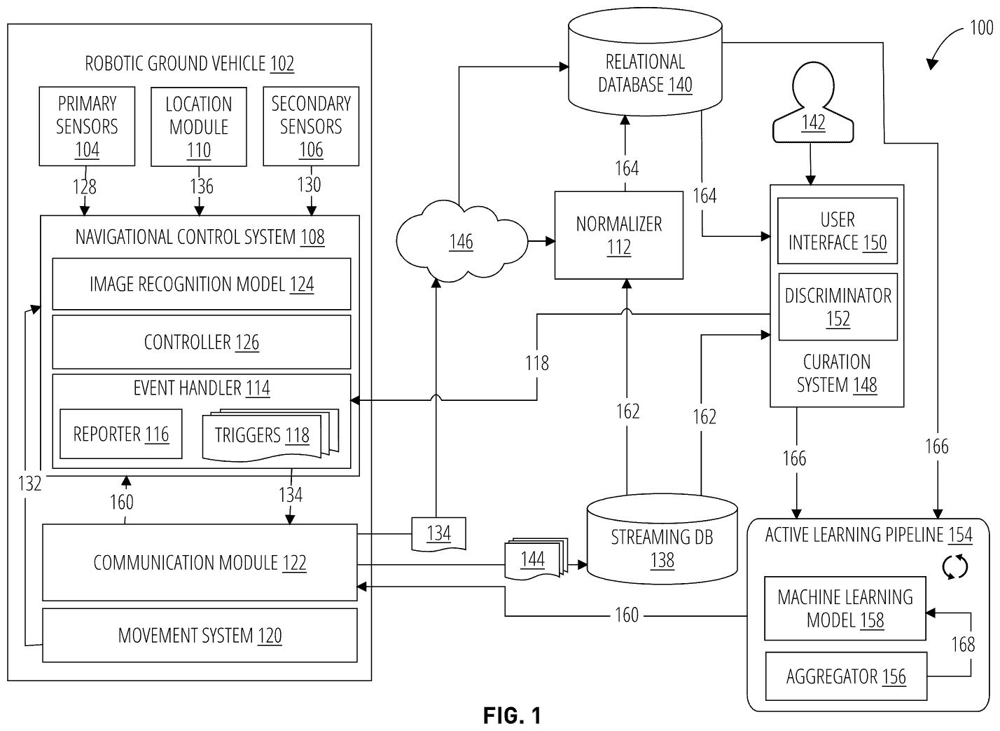

FIG. 1 illustrates an embodiment of the system 100. The system 100 comprises an autonomous ground vehicle 102, a cloud storage 146, a streaming database 138, a relational database 140, a curation system 148, and an active learning pipeline 154. The autonomous ground vehicle 102 comprises a primary sensors 104, a location module 110, a secondary sensors 106, a navigational control system 108, a communication module 122, and a movement system 120. The navigational control system 108 comprises an image recognition model 124, a controller 126, and an event handler 114. The event handler 114 comprises a reporter 116 and an event triggers 118. The curation system 148 comprises a user interface 150 and a discriminator 152. The active learning pipeline 154 comprises a machine learning model 158 and an aggregator 156.

In an embodiment, the system 100 is configured to detect a trigger event during operation of the autonomous ground vehicle 102 traveling between two physical locations. The system 100 generates event sequence data 134 from primary sensor data 128, secondary sensor data 130, spatiotemporal data 136, and telemetry data 132 through operation of the reporter 116. The system 100 communicates the event sequence data 134 to cloud storage 146 and raw data 144 to a streaming database 138. The system 100 transforms the raw data 144 into normalized data 164 stored in the relational database 140 through operation of the normalizer 112 configured by the event sequence data 134. The system 100 operates the curation system 148 to identify true trigger events from the normalized data 164 and extract training data 166 by way of a discriminator 152. The system 100 operates the machine learning model 158 within the active learning pipeline 154 to generate a model update 160 from aggregate training data 168 generated from the training data 166 by the aggregator 156. The system 100 reconfigures the navigational control system 108 with the model update 160 communicated from the active learning pipeline 154 to the autonomous ground vehicle 102.

In an embodiment, the system 100 configures the event handler 114 with the event triggers 118. The system 100 operates the navigational control system 108 to receive: the primary sensor data 128 from the primary sensors 104, the spatiotemporal data 136 from the location module 110, the secondary sensor data 130 from the secondary sensors 106, and the telemetry data 132 from the movement systems 120. The system 100 controls the movement systems 120 through operation of the controller 126 and the image recognition model 124 to transport the autonomous ground vehicle 102 between two physical locations. The system 100 communicates the raw data 144 comprising the primary sensor data 128, the secondary sensor data 130, the spatiotemporal data 136, and the telemetry data 132 to the streaming database 138 by way of the communication module 122. The system 100 operates the event handler 114 to monitor the primary sensor data 128, the secondary sensor data 130, the spatiotemporal data 136, and the telemetry data 132 for the event triggers 118.

In an embodiment, the system 100 communicates the raw data 162 to the curation system 148 from the streaming database 138. The system 100 operates the discriminator 152 to identify at least one trigger event in the raw data 144. The system 100 trigger the reporter 116 to generate the event sequence data 134.

In an embodiment, a user 142 configures the discriminator 152 through a user interface 150 to determine true trigger events from the raw data 144 into normalized data 164. The user 142 may also use the user interface 150 to trigger the generation of the event sequence data 134. Once the discriminator 152 determines a true trigger event the images or sequences of images related to the instance or sequence of the event may be provided as training data 166 to the active learning pipeline 154.

The active learning pipeline 154 includes the machine learning model 158 that may be a semantic segmentation model. The aggregator 156 collects images and sequences of images in the training data 166 to retrain the image recognition model 124. These images and sequences of images may be image detection errors by the model. The aggregator 156 collects the images as a negative training set used as the aggregate training data 168. The aggregate training data 168 used for the machine learning model 158 may include 100-1000 images. The machine learning model 158 may then generate a model update 160 which is communicated to the communication module 122 of the autonomous ground vehicle 102 which is then used to train the image recognition model 124 in the navigational control system 108.

In an embodiment, the training data 166 may include the telemetry data 132, the primary sensor data 128, the spatiotemporal data 136, and the secondary sensor data 130. The machine learning model 158 may be a machine learning model associated with the controller 126 and the training data may be provided to retrain the controller 126 with a model update.

In an embodiment, the primary sensors 104 may be accomplished by image sensors such as cameras, stereo cameras, Lidar, and etc., that generate an image or data capable of being processed as an image suitable for use by an image detection model. The primary sensors 104 may also be accomplished by sensors directly involved in the decision making of the controller 126 such as ultrasonic sensor or electrical field sensors. The secondary sensors 106 may be accomplished by the environmental sensors not immediately related to the movement of the autonomous ground vehicle 102 such as humidity sensors, temperature sensors, and etc. The location module 110 generates positional data and may be derived from satellite positioning data, such as GPS, RTK, GLASNOS, etc., but may also be accomplished by triangulation from near field communication signals such as Bluetooth, Wi-Fi, cellular signals, RFID, etc., and the triangulation of the signals to determine relative positioning. The telemetry data 132 may be provided by the movement system 120 such as velocity, internal states, etc., but may also include battery status, internal temperatures, and etc.

In an embodiment, the primary sensors 104 may include multi dimensional image data provided by a complex of sensor data or sensor data from a multi dimensional sensor such as LIDAR. The multi dimensional image data may be provided as a point cloud map produced by Simultaneous Localization and Mapping (SLAM) technique. SLAM is a method used for autonomous robots/vehicles that allows them to build a map and localize on that map at the same time. There are many SLAM algorithms that allow the robot to map out unknown environments. Map information is used to carry out tasks such as path planning and obstacle avoidance. Constructing the map and localizing the robot in them is done using a wide range of algorithms, computations, and sensory data.

SLAM can be used in both indoor and outdoor applications, in which different algorithms can be used. The next paper is an example of how SLAM can be able to map and locate a device within an environment that can be either indoors or outdoors. Additionally, there are at least different versions of SLAM that may be operated ORB-SLAM3, OpenVSLAM, and RTABMap.

ORB-SLAM3 is a project that provides a versatile visual SLAM tailored to operate a wide variety of sensors: monocular, stereo, and RGB-D cameras. It uses Oriented FAST and rotated BRIEF (ORB) to track features in short and medium terms. On the other hand, the project uses DBoW2 for long-term feature association. It has been widely used since 2015 and has found applications in service robots.

OpenVSLAM is an implementation of an ORB feature-based visual graph SLAM. It includes optimized feature extractors and stereo matchers, however, its main feature is a unique frame tracking module. This tracking module allows OpenVSLAM to perform fast and accurate localization. OpenVSLAM also allows using more cameras than other VSLAM implementations. The whole package was not developed for research purposes but to be used by industrial users. it must be noted that this project is the most recent approach out of the three, being liberated in 2019.

RTABMap is one of the oldest SLAM approaches. It was released back in 2013 yet it still has active maintenance and support. It covers input sensors such as stereo, RBG-D, fish-eye cameras, odometry, and 2D/3D LiDAR data. It has been a part of ROS for a long time. RTABMap creates dense 3D and 2D representations of the environment that can be used as a pure 2D SLAM. It is currently used in the hobby, research, and small-scale service robots.

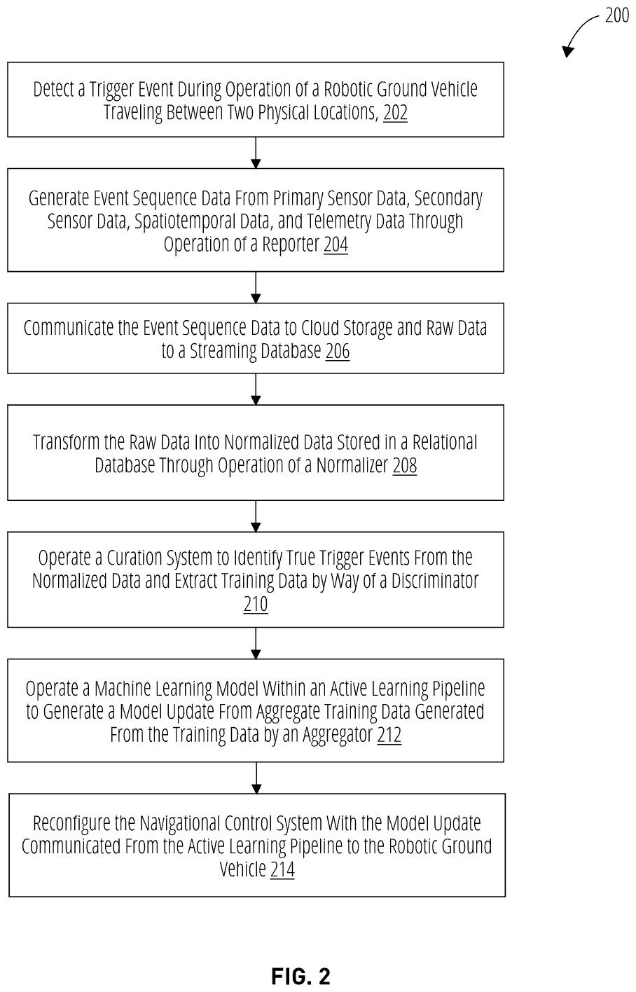

FIG. 2 illustrates an embodiment of a method 200. In block 202, the method 200 detects a trigger event during operation of an autonomous ground vehicle traveling between two physical locations, wherein the autonomous ground vehicle comprises primary sensors, secondary sensors, a location module, a navigational control system, a communication module, and movement systems. In block 204, the method 200 generates event sequence data from primary sensor data, secondary sensor data, spatiotemporal data, and telemetry data through operation of a reporter. In block 206, the method 200 communicates the event sequence data to cloud storage and raw data to a streaming database. In block 208, the method 200 transforms the raw data into normalized data stored in a relational database through operation of a normalizer. In block 210, the method 200 operates a curation system to identify true trigger events from the normalized data and extract training data by way of a discriminator. In block 212, the method 200 operates a machine learning model within an active learning pipeline to generate a model update from aggregate training data generated from the training data by an aggregator. In block 214, the method 200 reconfigures the navigational control system with the model update communicated from the active learning pipeline to the autonomous ground vehicle.

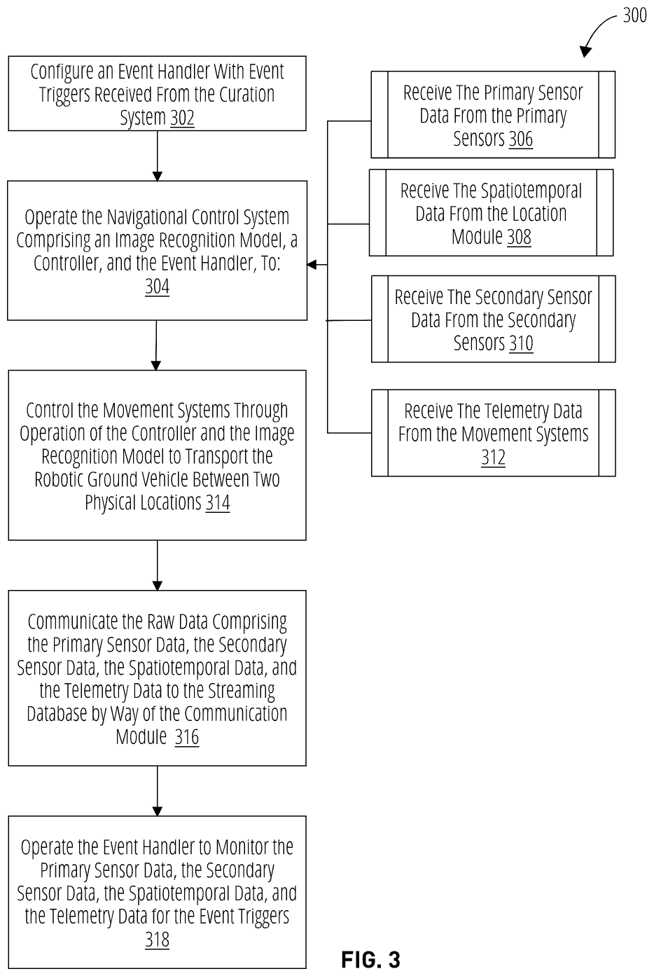

FIG. 3 illustrates an embodiment of a method 300. In block 302, method 300 configures an event handler with event triggers. In block 304, method 300 operates the navigational control system comprising an image recognition model, a controller, and the event handler, to receive the primary sensor data from the primary sensors (subroutine block 306), receive the spatiotemporal data from the location module (subroutine block 308), receive the secondary sensor data from the secondary sensors (subroutine block 310), and receive the telemetry data from the movement systems (subroutine block 312). In block 314, the method 300 controls the movement systems through operation of the controller and the image recognition model to transport the autonomous ground vehicle between two physical locations. In block 316, the method 300 communicates the raw data comprising the primary sensor data, the secondary sensor data, the spatiotemporal data, and the telemetry data to the streaming database by way of the communication module. In block 318, the method 300 operates the event handler to monitor the primary sensor data, the secondary sensor data, the spatiotemporal data, and the telemetry data for the event triggers.

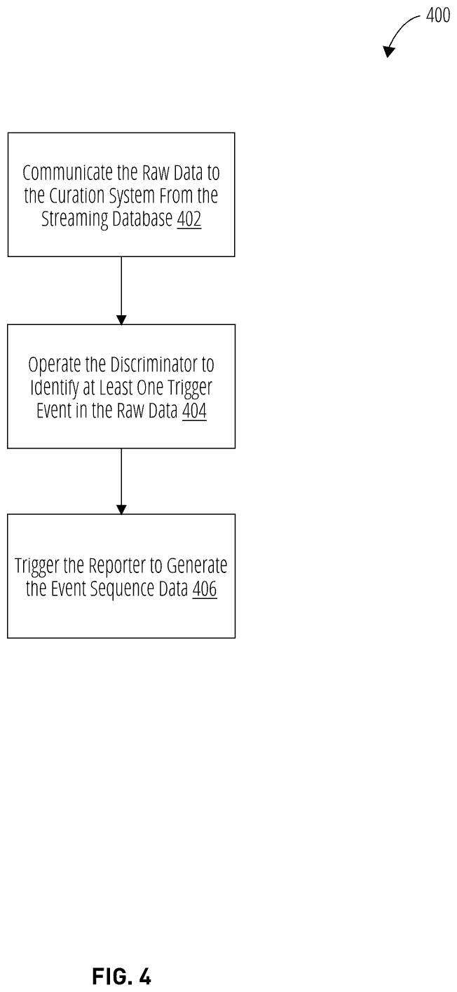

FIG. 4 illustrates an embodiment of a method 400. In block 402, the method 400 communicates the raw data to the curation system from the streaming database. In block 404, the method 400 operates the discriminator to identify at least one trigger event in the raw data. In block 406, the method 400 triggers the reporter to generate the event sequence data.

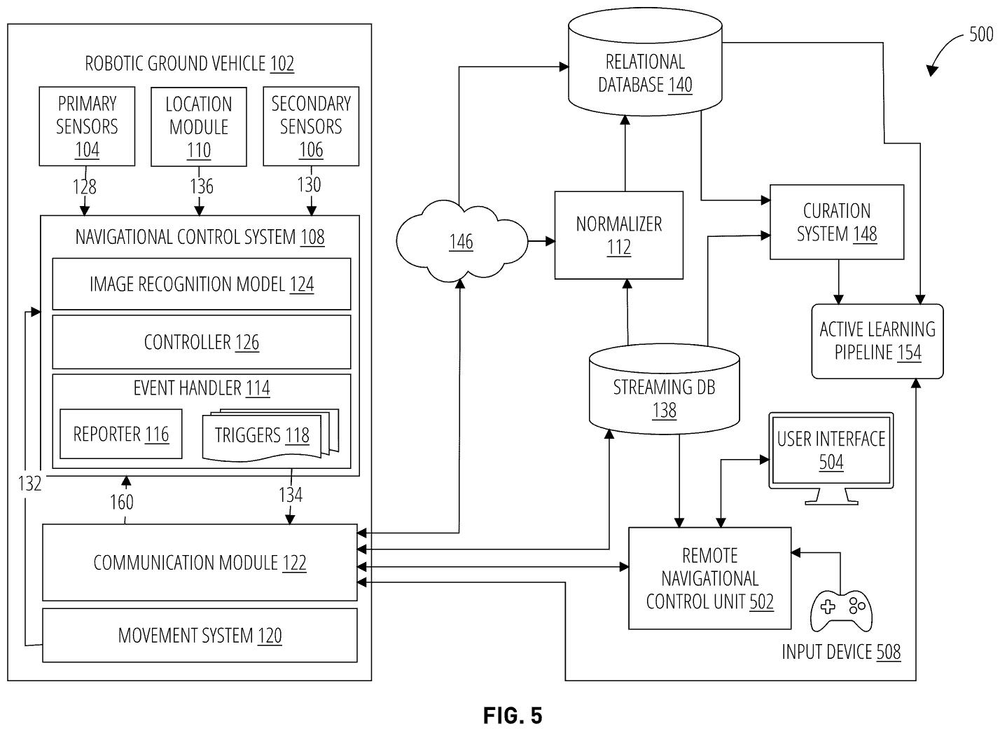

FIG. 5 illustrates an embodiment of a system 500. The system 500 comprises the autonomous ground vehicle 102, the normalizer 112, the relational database 140, the curation system 148, the active learning pipeline 154, and a remote navigational control unit 502 with at least a user interface 504. The remote navigational control unit 502 is provided as a remote operations system allowing a user to control movement system 120 and operation of the autonomous ground vehicle 102 (e.g., Teleoperations, C2C, etc.,). In some configurations, the primary sensor data 128, the secondary sensor data 130, the spatiotemporal data 136, and the telemetry data 132 may be communicated through the communication module 122 to the remote navigational control unit 502 and configured for viewing on the user interface 504. A user may control the autonomous ground vehicle 102 directly through the user interface 504 or through the use of an input device 508. In some configuration, the remote navigational control unit 502 may view information from the autonomous ground vehicle 102 directly from the autonomous ground vehicle 102 or by way of the streaming database 138 and communicate directly with the autonomous ground vehicle 102.

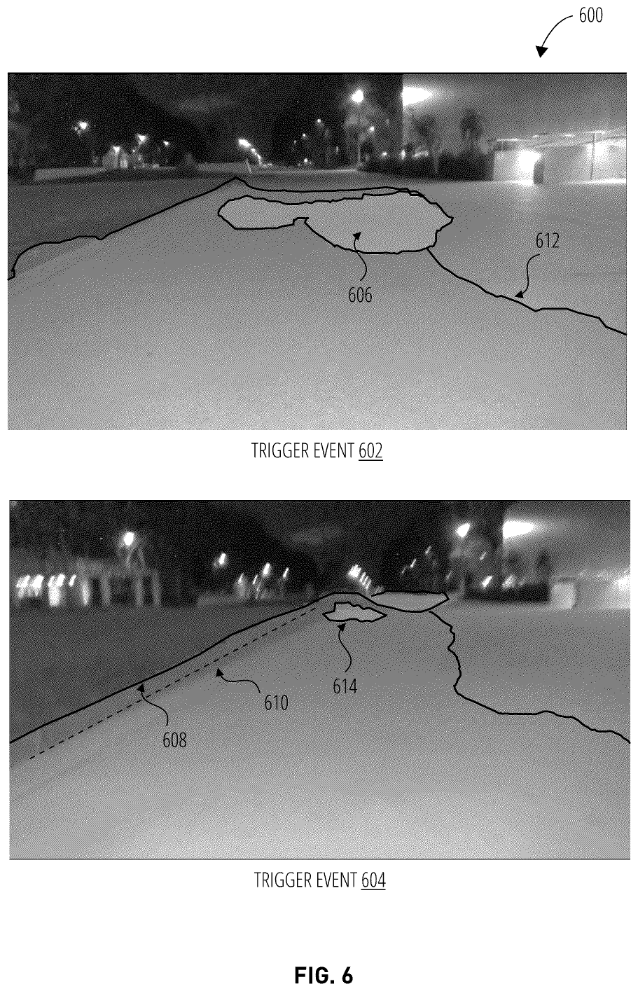

FIG. 6 illustrates an embodiment of an image data 600. The image data 600 illustrates true trigger events, trigger event 602 and trigger event 604. In the trigger event 602 the image recognition model identifies an illuminated area as an obstacle 606 in the middle of a sidewalk. The image recognition model additionally moves the boundary line 612 of a projected path for the autonomous ground vehicle to exclude unobstructed areas. In trigger event 604, the image recognition model moves the boundary line 608 away from the edge of the sidewalk and identifies the edge of the sidewalk, a physical obstacle 610, as a safe movement path. In the trigger event 604, an obstacle 614 is erroneously detected. These true trigger events may be caused by the shadows or inconsistent lighting.

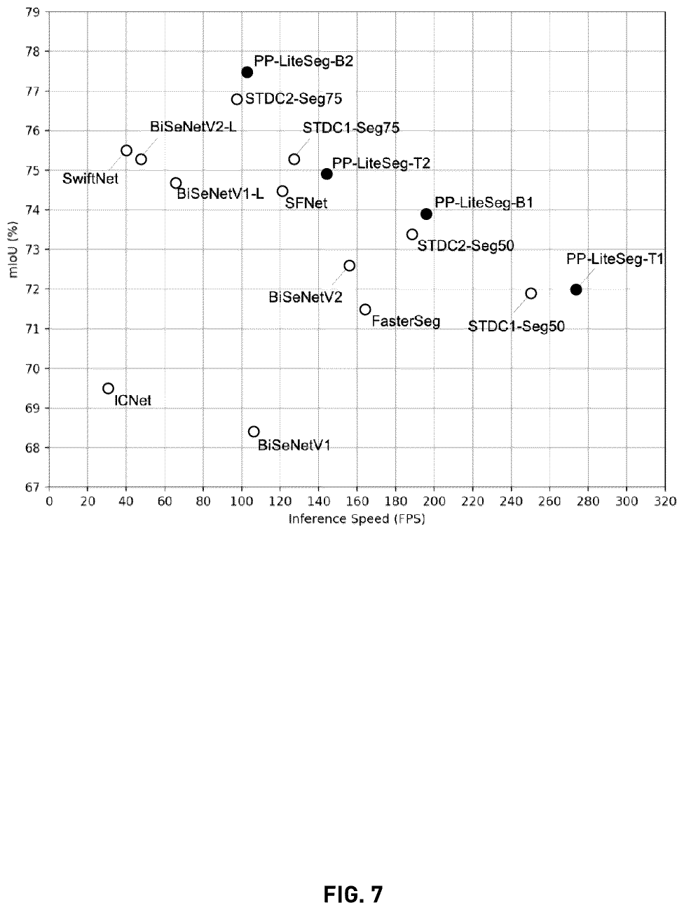

In an embodiment, the image recognition model and the machine learning model may be accomplished by one or more of the semantic segmentation models discussed in FIG. 7 through FIG. 12.

FIG. 7 illustrates the comparison of segmentation accuracy (mIoU) and inference speed (FPS) on the Cityscapes test set. The black dots represent proposed PP-LiteSeg. The testing device is NVIDIA GTX 1080Ti. The experimental results demonstrate that PPLiteSeg achieves state-of-the-art trade-off between accuracy and speed.

Semantic segmentation aims to precisely predict the label of each pixel in an image. It has been widely applied in real-world applications, e.g. medical imaging, autonomous driving, video conferencing, semiautomatic annotation. As a fundamental task in computer vision, semantic segmentation has attracted a lot of attention from researchers. With the remarkable progress of deep learning, a lot of semantic segmentation methods have been proposed based on convolutional neural network. FCN is the first fully convolutional network trained in an end-to-end and pixel-to-pixel way. It also presents the primitively encoder-decoder architecture in semantic segmentation, which is widely adopted in subsequent methods. To achieve higher accuracy, PSPNet utilizes a pyramid pooling module to aggregate global context and SFNet proposes a flow alignment module to strengthen the feature representations.

Yet, these models are not suitable for real-time applications because of their high computation cost. To accelerate the inference speed, Espnetv2 utilizes light-weight convolutions to extract features from an enlarged receptive field. BiSeNetV2 proposes bilateral segmentation network and extracts the detail features and semantic features separately. STDCSeg designs a new backbone named STDC to improve the computation efficiency. However, these models do not achieve satisfactory trade-off between accuracy and speed.

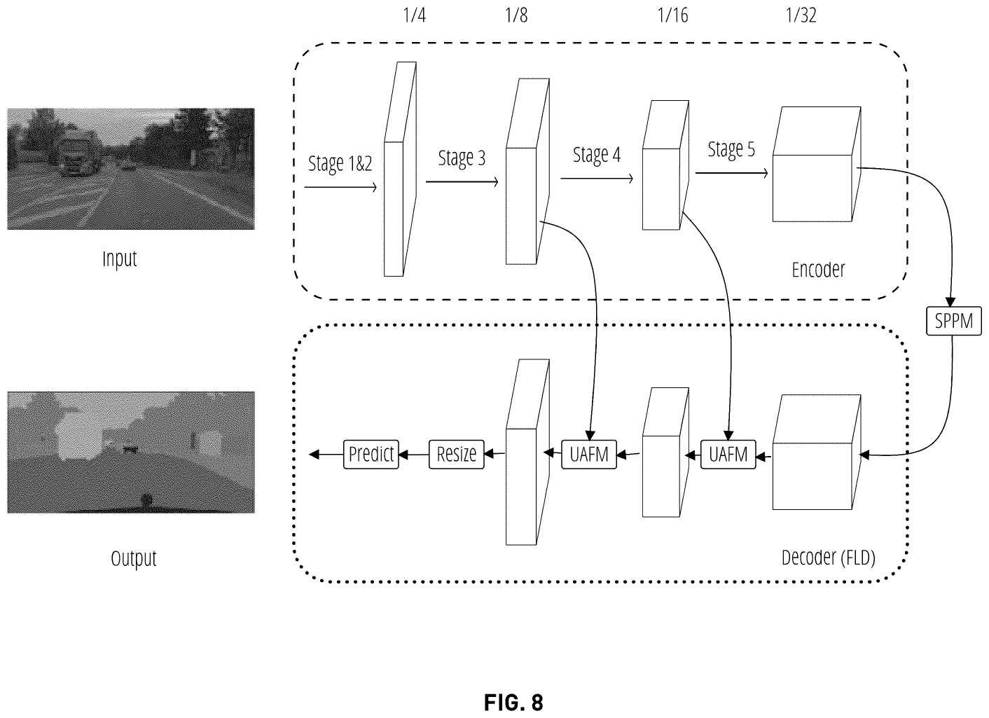

As illustrated in FIG. 8, PPLiteSeg adopts the encode-decoder architecture and consists of three novel modules: Flexible and Lightweight Decoder (FLD), Unified Attention Fusion Module (UAFM) and Simple Pyramid Pooling Module (SPPM). The motivations and details of these modules are introduced as follows.

The encoder in semantic segmentation models extracts hierarchical features, and the decoder fuses and unsamples features. For the features from low level to high level in encoder, the number of channels increases and the spatial size decreases, which is an efficient design. For the features from high level to low level in decoder, the spatial size increases, while the number of channels is the same in recent models. Therefore, a Flexible and Lightweight Decoder (FLD) is presented, which gradually reduces the channels and increases the spatial size for the features. Besides, the volume of proposed decoder can be easily adjusted according to the encoder. The flexible design balances the computation complexity of encoder and decoder, which makes the overall model more efficient.

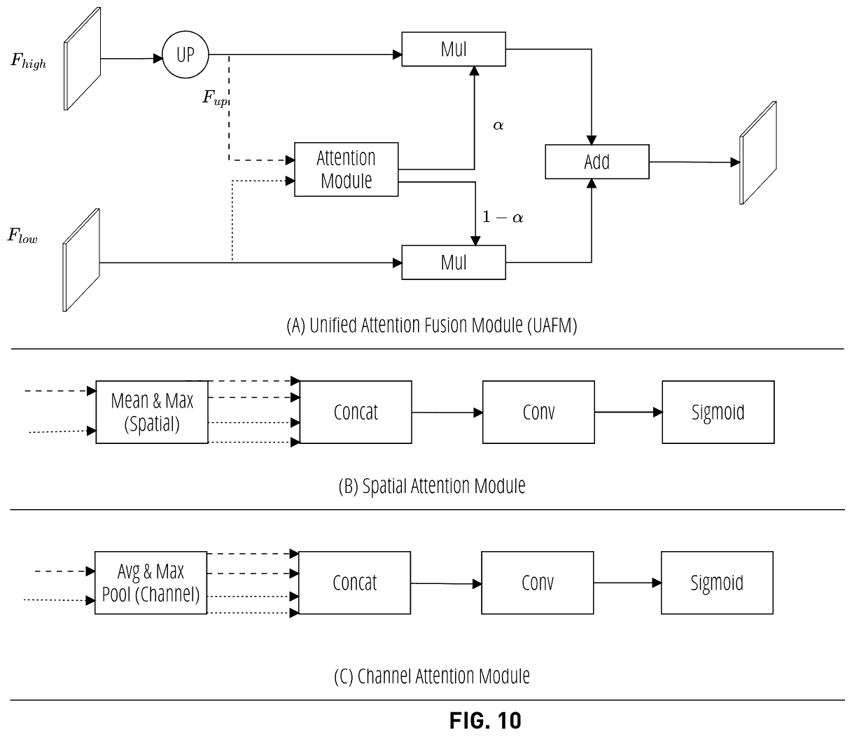

Strengthening feature representations is a crucial way to improve segmentation accuracy. It is usually achieved by fusing the low-level and high-level features in a decoder. However, the fusion modules in existing methods usually suffer from high computation cost. A Unified Attention Fusion Module (UAFM) is proposed to strengthen feature representations efficiently. As shown in FIG. 10, UAFM first takes advantage of the attention module to produce weight, and then fuses the input features with o. In UAFM, there are two kinds of attention modules, i.e. spatial and channel attention modules, which exploit inter-spatial and inter-channel relationships of the input features.

Contextual aggregation is another key to promoting segmentation accuracy, but previous aggregation modules are time-consuming for real-time networks. Based on the framework of PPM, a Simple Pyramid Pooling Module (SPPM), which reduces the intermediate and output channels, removes the short-cut, and replaces the concatenate operation with an add operation. Experimental results show that SPPM contributes to the segmentation accuracy with low computation cost.

The proposed PP-LiteSeg were evaluated through extensive experiments on Cityscapes and Cam Vid dataset. As illustrated in FIG. 7, PP-LiteSeg achieves a superior tradeoff between segmentation accuracy and inference speed. Specifically, PP-LiteSeg achieves 72.0% mIoU/273.6 FPS and 77.5% mIoU/102.6 FPS on the Cityscapes test set.

### Semantic Segmentation

Deep learning has helped semantic segmentation make remarkable leap-forwards. FCN is the first full convolutional network for semantic segmentation. It is trained in an end-to-end and pixel-to-pixel way. Besides, images with arbitrary size can be segmented by FCN. Following the design of FCN, various methods have been proposed in later. Segnet applies the indices of max-pooling operation in encoder to upsampling operation in decoder. Therefore, the information in decoder is reused and the decoder produces refined features. PSPNet proposes the pyramid pooling module to aggregate local and global information, which is effective for segmentation accuracy. Besides, recent semantic segmentation methods utilize the transformer architecture to achieve better accuracy.

### Realtime Semantic Segmentation

To fulfill the real-time demands of semantic segmentation, lots of methods have been proposed, e.g., lightweight module design, dual-branch architecture, early-down sampling strategy, and multiscale image cascade network. ENet uses an early-down sampling strategy to reduce the computation cost of processing large images and feature maps. For efficiency, ICNet designs a multi-resolution image cascade network. Based on bilateral segmentation network, Bisenet extracts the detail features and semantic features separately. The bilateral network is lightweight, so the inference speed is fast. STDCSeg proposes the channel-reduced receptive field-enlarged STDC module and designs an efficient backbone, which can strengthen the feature representations with low computation cost. To eliminate the redundancy in two-branch network, STDCSeg guides the features with detailed ground truth, so the efficiency is further improved. Espnetv2 uses group point-wise and depth-wise dilated separable convolutions to learn features from an enlarged receptive field in a computation friendly manner.

### Feature Fusion Module

The feature fusion module is commonly used in semantic segmentation to strengthen feature representations. In addition to the element-wise summation and concatenation methods, researchers propose several methods as follows. In BiSeNet, the BGA module employs element-wise Mul method to fuse the features from the spatial and contextual branches. To enhance the features with high-level context, DFANet fuses features in a stage-wise and subnet-wise way. To tackle the problem of misalignment, SFNet and AlignSeg first learn the transformation offsets through a CNN module, and then apply the transformation offsets to grid sample operation to generate the refined feature. In detail, SFNet designs the flow alignment module. AlignSeg designs aligned feature aggregation module and the aligned context modeling module. FaPN solves the feature misalignment problem by applying the transformation offsets to deformable convolution.

### Flexible Lightweight Decoder

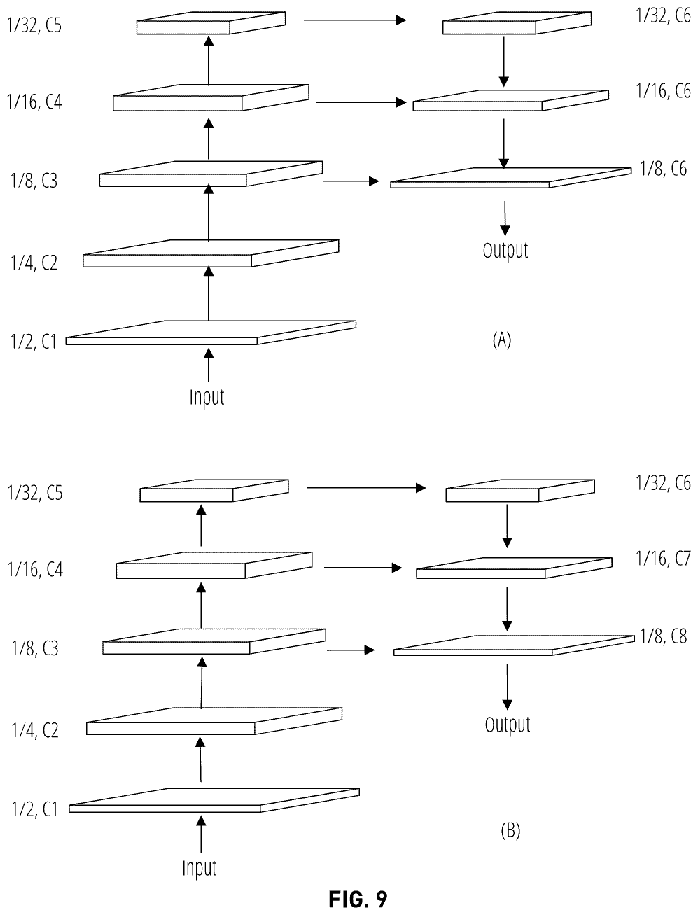

Encoder-decoder architecture has been proved to be effective for semantic segmentation. In general, the encoder utilizes a series of layers grouped into several stages to extract hierarchical features. For the features from low level to high level, the number of channels gradually increases and the spatial size of the features decreases. This design balances the computation cost of each stage, which ensures the efficiency of the encoder. The decoder also has several stages, which are responsible for fusing and up sampling features. Although the spatial size of features increases from high level to low level, the decoder in recent lightweight models keeps the feature channels the same in all levels. Therefore, the computation cost of the shallow stage is much larger than that of the deep stage, which leads to the computation redundancy in the shallow stage. To improve the efficiency of the decoder, we present a Flexible and Lightweight Decoder (FLD). As illustrated in FIG. 9, FLD gradually decreases the channels of the features from high level to low level. FLD can easily adjust the computation cost to achieve a better balance between the encoder and decoder. Although the channels of features in FLD are decreasing, the experiments show that PP-LiteSeg achieves competitive accuracy compared to other methods.

### Unified Attention Fusion Module

As discussed above, fusing multi-level features is essential to achieve high segmentation accuracy. In addition to the element-wise summation and concatenation methods, researchers propose several methods, e.g. SFNet, FaPN and AttaNet. A Unified Attention Fusion Module (UAFM) is proposed that applies channel and spatial attention to enrich the fused feature representations.

### UAFM Framework.

As illustrated in FIG. 10, UAFM utilizes an attention module to produce the weight α, and fuses the input features with a by Mul and Add operations. In detail, the input features are denoted as F_{high} and F_{low}. F_{high} is the output of the deeper module, and F_{low} is the counterpart from the encoder. Note that they have the same channels. UAFM first makes use of bilinear interpolation operation to upsample F_{high} to the same size of F_{low}, while the upsampled feature is denoted as Fᵤₚ. Then, the attention module takes Fᵤₚ and F_{low} as input and produces the weight α. Note that, the attention module can be a plugin, such as a spatial attention module, channel attention module, etc. After that, to obtain attention-weighted features, we apply the element-wise Mul operation to Fᵤₚ and F_{low}, respectively. Finally, UAFM performs element-wise addition for the attention-weighted features and outputs the fused feature. The above procedure is formulated as equation 1.

$${F}_{up} = Upsample ( {F}_{high} ) \\ α = Attention ( {F}_{up} , {F}_{low} ) \\ {F}_{out} = {F}_{up} \cdot α + {F}_{low} \cdot ( 1 - α ) \qquad Equation 1$$

### Spatial Attention Module.

The motivation of the spatial attention module is exploiting the inter-spatial relationship to produce a weight, which represents the importance of each pixel in the input features. As shown in FIG. 10 (b), given the input features, i.e., Fᵤₚ∈R^{C×H×W} and F_{low}∈R^{C×H×W}, we first perform mean and max operations along the channel axis to generates four features, of which the dimension is R^{1×H×W}. Afterwards, these four features are concatenated to a feature Fₑₓₜ∈R^{4×H×W}. For the concatenated feature, the convolution and sigmoid operations are applied to output α∈R^{1×X×W}. The formulation of the spatial attention module is shown in equation 2. Furthermore, the spatial attention module can be flexible, e.g. removing the max operation to reduce computation cost.

$${F}_{cat} = Concat ( Mean ( {F}_{up} ) , Max ( {F}_{up} ) , \\ Mean ( {F}_{low} ) , Max ( {F}_{low} ) ) \\ α = Sigmoid ( Conv ( {F}_{cat} ) ) \qquad Equation 2$$

### Channel Attention Module.

The key concept of the channel attention module is leveraging the inter-channel relationship to generate a weight, which indicates the importance of each channel in the input features. As shown in FIG. 10 (b), the proposed channel attention module utilizes average-pooling and max-pooling operations to squeeze the spatial dimension of input features. This procedure generates four features with the dimension R^{C×1×1}. Then, it concatenates these four features along the channel axis and performs convolution and sigmoid operations to produce a weight α∈R^{C×1×1}. In short, the procedures of the channel attention module can be formulated as equation 3.

$${F}_{cat} = Concat ( AvgPool ( {F}_{up} ) , Max Pool ( {F}_{up} ) , \\ AvgPool ( {F}_{low} ) , Max Pool ( {F}_{low} ) ) \\ α = Sigmoid ( Conv ( {F}_{cat} ) ) \qquad Equation 3$$

### Simple Pyramid Pooling Module

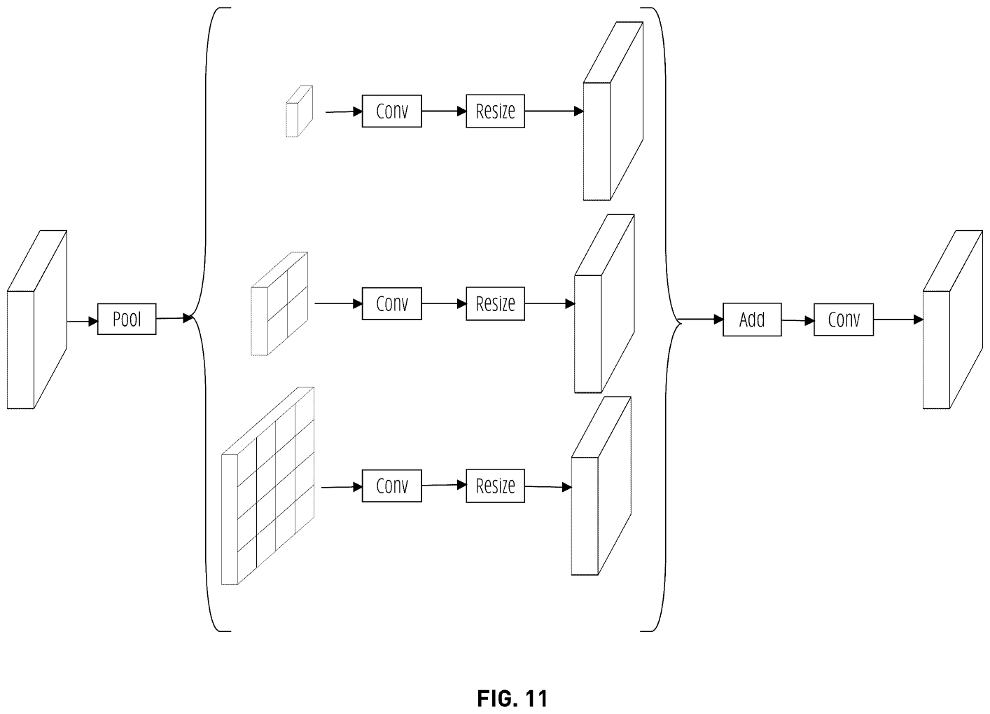

FIG. 11 illustrates a proposed Simple Pyramid Pooling Module (SPPM). It first leverages the pyramid pooling module to fuse the input feature. The pyramid pooling module has three global-average-pooling operations and the bin sizes are 1×1, 2×2, and 4×4 respectively. Afterwards, the output features are followed by the convolution and up sampling operations. For the convolution operation, the kernel size is 1×1 and the output channel is smaller than the input channel. Finally, we add these up sampled features and apply a convolution operation to produce the refined feature. Compared to original PPM, SPPM reduces the intermediate and output channels, removes the short-cut, and replaces the concatenate operation with an addition operation. Consequently, SPPM is more efficient and suitable for real-time models.

TABLE 1

| Model | Encoder | Channels in Decoder |
|---|---|---|
| PP-LiteSeg-T | STDC1 | 32, 64, 128 |
| PP-LiteSeg-B | STDC2 | 64, 96, 128 |

### Network Architecture

The architecture of the proposed PP-LiteSeg is demonstrated in FIG. 8. PP-LiteSeg mainly comprises three modules: encoder, aggregation and decoder.

Firstly, given an input image, PP-Lite utilizes a common lightweight network as encoder to extract hierarchical features. In detail, we choose the STDCNet for its outstanding performance. The STDCNet has 5 stages, the stride for each stage is 2, so the final feature size is 1/32 of the input image. As shown in Table 1, we present two versions of PP-LiteSeg, i.e., PP-LiteSeg-T and PP-LiteSeg-B, of which the encoder is STDC1 and STDC2 respectively. The PPLiteSeg-B achieves higher segmentation accuracy, while the inference speed of PP-LiteSeg-T is faster. It is worth noting that we apply the SSLD method to the training of the encoder and obtain enhanced pre-trained weights, which is beneficial for the convergence of segmentation training.

Secondly, PP-LiteSeg adopts SPPM to model the long range dependencies. Taking the output feature of the encoder as input, SPPM produces a feature that contains global context information.

Finally, PP-LiteSeg utilizes proposed FLD to gradually fuse multi-level features and output the resulting image. Specifically, FLD consists of two UAFM and a segmentation head. For efficiency, the spatial attention module is utilized in UAFM. Each UAFM takes two features as input, i.e., a low-level feature extracted by the stages of the encoder, a high-level feature generated by SPPM or the deeper fusion module. The latter UAFM outputs fused features with the down-sample ratio of ⅛. In the segmentation head, we perform Conv-BN-Relu operation to reduce the channels of the ⅛ down-sample feature to the number of classes. An upsampling operation is followed to expand the feature size to the input image size, and an argmax operation predicts the label of each pixel. The cross entropy loss with Online Hard Example Mining is adopted to optimize the models.

### Datasets and Implementation Details

### Cityscapes.

The Cityscapes is a large-scale dataset for urban segmentation. It contains 5,000 fine annotated images, which are further split into 2975, 1600, and 1525 images for training, validation and testing, respectively. The resolution of the images is 2048×1024, which poses great challenges for the real-time semantic segmentation methods. The annotated images have 30 classes and the experiments only use 19 classes for a fair comparison with other methods.

### CamVid.

Cambridge-driving Labeled Video Database (Cam Vid) is a small-scale dataset for road scene segmentation. There are 701 images with high-quality pixel level annotations, in which 367, 101 and 233 images are chosen for training, validation and testing respectively. The images have the same resolution of 960×720. The annotated images provide 32 categories, of which a subset of 11 are used in the experiments.

### Training Settings.

Following the common setting, the stochastic gradient descent (SGD) algorithm with 0.9 momentum is chosen as an optimizer. A warm-up strategy and the “poly” learning rate scheduler was also adopted. For Cityscapes, the batch size is 16, the max iterations are 160,000, the initial learning rate is 0.005, and the weight decay in the optimizer is 5e⁻⁴. For CamVid, the batch size is 24, the max iterations is 1,000, the initial learning rate is 0.01, and the weight decay is 1e⁻⁴. For data augmentation, random scaling, random cropping, random horizontal flipping, random color jittering and normalization may be utilized. The random scale ranges in [0.125, 1.5], [0.5, 2.5] for Cityscapes and Camvid respectively. The cropped resolution of Cityscapes is 1024×1612, and the cropped resolution of CamVid is 960×720. All of the experiments are conducted on Tesla V100 GPU using PaddlePaddle1. Code and pretrained models are available at PaddleSeg2.

### Inference Settings.

For a fair comparison, we export PPLiteSeg to ONNX and utilize TensorRT to execute the model. Similar to other methods, an image from Cityscapes is first resized to 1024×1612 and 1536×768, then the inference model takes the scaled image and produces the predicted image, finally, the predicted image is resized to the original size of the input image. The cost of the three steps is counted as the inference time. For Cam Vid, the inference model takes the original image as input, while the resolution is 960×720. We conduct all inference experiments under CUDA 10.2, CUDNN 7.6, TensorRT 7.1.3 on NVIDIA 1080Ti GPU. The standard mIoU for segmentation accuracy comparison and FPS for inference speed comparison was employed.

TABLE 2

| | | | mIoU (%) | | |
|---|---|---|---|---|---|
| Model | Encoder | Resolution | val | test | FPS |
| ENet | — | 512 × 1024 | — | 58.3 | 76.9 |
| ICNet | PSPNet50 | 1024 × 2048 | — | 69.5 | 30.3 |
| ESPNet | ESPNet | 512 × 1024 | — | 60.3 | 112.9 |
| ESPNetV2 | ESPNetV2 | 512 × 1024 | 66.4 | 66.2 | — |
| SwiftNet | ResNet18 | 1024 × 2048 | 75.4 | 75.5 | 39.9 |
| BiSeNetV1 | Xception39 | 768 × 1536 | 69.0 | 68.4 | 105.8 |
| BiSeNetV1-L | ResNet18 | 768 × 1536 | 74.8 | 74.7 | 65.5 |
| BiSeNetV2 | — | 512 × 1024 | 73.4 | 72.6 | 156 |
| BiSeNetV2-L | — | 512 × 1024 | 75.8 | 75.3 | 47.3 |
| FasterSeg | — | 1024 × 2048 | 73.1 | 71.5 | 163.9 |
| SFNet | DF1 | 1024 × 2048 | — | 74.5 | 121 |
| STDC1-Seg50 | STDC1 | 512 × 1024 | 72.2 | 71.9 | 250.4 |
| STDC2-Seg50 | STDC2 | 512 × 1024 | 74.2 | 73.4 | 188.6 |
| STDC1-Seg75 | STDC1 | 768 × 1536 | 74.5 | 75.3 | 126.7 |
| STDC2-Seg75 | STDC2 | 768 × 1536 | 77.0 | 76.8 | 97.0 |
| PP-LiteSeg-T1 | STDC1 | 512 × 1024 | 73.1 | 72.0 | 273.6 |
| PP-LiteSeg-B1 | STDC2 | 512 × 1024 | 75.3 | 73.9 | 195.3 |
| PP-LiteSeg-T2 | STDC1 | 768 × 1536 | 76.0 | 74.9 | 143.6 |
| PP-LiteSeg-B2 | STDC2 | 768 × 1536 | 78.2 | 77.5 | 102.6 |

Comparisons with State-of-the-Arts

With the training and inference setting mentioned above, we compare the proposed PP-LiteSeg with previous stateof-the-art real-time models on Cityscapes. For fair comparison, PP-LiteSeg-T and PP-LiteSeg-B were evaluated at two resolutions, i.e., 1612×1024 and 768×1536. Table 2 shows the comparisons with state-of-the-art real-time methods on Cityscapes. The training and inference setting refer to the implementation details and presents the model information, input resolution, mIoU, and FPS of various approaches. FIG. 7 provides an intuitive comparison of segmentation accuracy and inference speed. The experimental evaluations demonstrate that the proposed PP-LiteSeg achieves a state-of-the-art trade-off between accuracy and speed against other methods. Specifically, we can observe PP-LiteSeg-T1 achieves 273.6 FPS and 72.0% mIoU, which means the fastest inference speed and competitive accuracy. With the resolution of 768×1536, PPLiteSeg-B2 achieves the best accuracy, i.e. 78.2% mIoU for the validation set, 77.5% mIoU for the test set. In addition, with same encoder and input resolution as STDC-Seg, PPLiteSeg shows better performance.

TABLE 3

| Model | FLD | SPPM | UAFM | mIoU(%) | FPS |
|---|---|---|---|---|---|
| Baseline | | | | 77.50 | 110.9 |
| PP-LiteSeg-B2 | ✓ | | | 77.67 | 109.7 |
| PP-LiteSeg-B2 | ✓ | ✓ | | 77.76 | 106.3 |
| PP-LiteSeg-B2 | ✓ | | ✓ | 77.89 | 105.5 |
| PP-LiteSeg-B2 | ✓ | ✓ | ✓ | 78.21 | 102.6 |

### Ablation Study

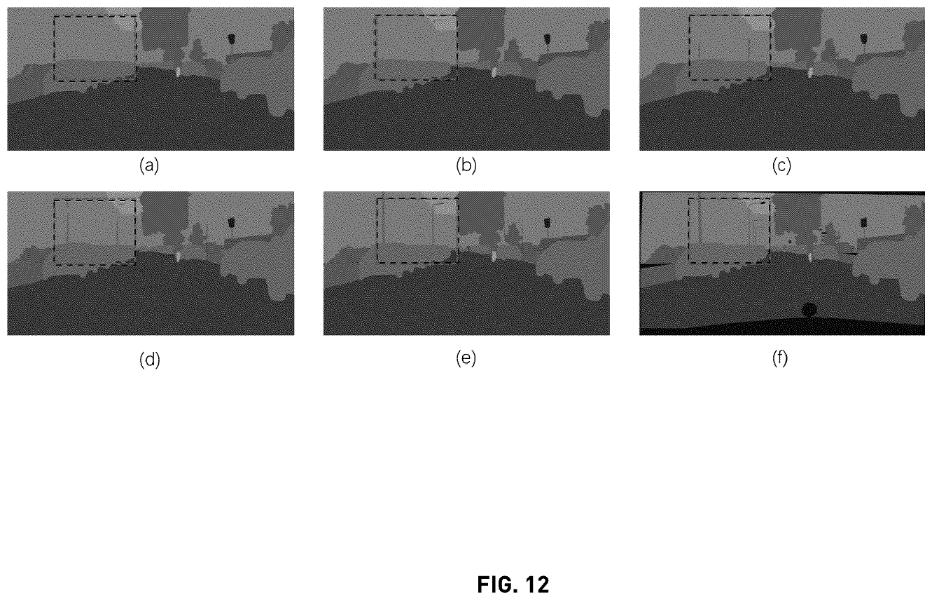

Ablation experiments are conducted to demonstrate the effectiveness of the proposed modules. The experiments choose PP-LiteSeg-B2 in the comparison and use the same training and inference setting. The baseline model is the PP-LiteSeg-B2 without the proposed modules, while the number of features channels is 96 in decoder and the fusion method is element-wise summation. Table 3 presents the quantitative results of the ablation study. It can be found that the FLD in PP-LiteSeg-B2 improves the mIoU by 0.17%. Adding SPPM and UAFM also improve the segmentation accuracy, while the inference speed slightly decreases. Based on three proposed modules, PP-LiteSeg-B2 achieves 78.21 mIoU with 102.6 FPS. The mIoU is boosted by 0.71% compared to the baseline model. FIG. 12 provides the qualitative comparisons. It is observed that the predicted image becomes more consistent with the ground truth when adding FLD, SPPM and UAFM one by one. In short, the proposed modules are effective for semantic segmentation.

TABLE 4

| Model | Encoder | mIoU (%) | FPS |
|---|---|---|---|
| ENet | — | 51.3 | 61.2 |
| ICNet | PSPNet50 | 67.1 | 34.5 |
| DFANet A | Xception A | 64.7 | 120 |
| SwiftNet | ResNet18 | 72.58 | — |
| BiSeNetV1 | Xception39 | 65.6 | 175 |
| BiSeNetV1-L | ResNet18 | 68.7 | 116.3 |
| BiSeNetV2 | — | 72.4 | 124.5 |
| BiSeNetV2-L | — | 73.2 | 32.7 |
| STDC1-Seg | STDC1 | 73.0 | 197.6 |
| STDC2-Seg | STDC2 | 73.9 | 152.2 |
| PP-LiteSeg-T | STDC1 | 73.3 | 222.3 |
| PP-LiteSeg-B | STDC2 | 75.0 | 154.8 |

### Experiments on CamVid

To further demonstrate the capability of PP-LiteSeg, we also conduct experiments on the Cam Vid dataset. Similar to other works, the input resolution for training and inference is 960×720. As shown in Table 4, PP-LiteSeg-T achieves 222.3 FPS, which is over 12.5% faster than other methods. PP-LiteSeg-B achieves the best accuracy, i.e., 75.0% mIoU with 154.8 FPS. Overall, the comparisons show PP-LiteSeg achieves a state-of-the-art trade-off between accuracy and speed on Camvid.

FIG. 8 illustrates the architecture overview of PP-LiteSeg. PP-Liteseg consists of includes three modules: encoder, aggregation and decoder. A lightweight network is used as encoder to extract the features from different levels. The Simple Pyramid Pooling Module (SPPM) is responsible for aggregating the global context. The Flexible and Lightweight Decoder (FLD) fuses the detail and semantic features from high level to low level and outputs the result. Remarkably, FLD uses the Unified Attention Fusion Module (UAFM) to strengthen feature representations.

FIG. 9 illustrates (a) The conventional encoder-decoder, in which the decoder keeps the features channels the same. (b) The encoder and proposed Flexible and Lightweight Decoder (FLD). FLD gradually reduces the channels for the features from high level to low level. Moreover, the volume of FLD is adjusted to conform to the encoder.

FIG. 10 illustrates The framework of Unified Attention Fusion Module (UAFM) as (a), the Spatial Attention Module as (b), and the Channel Attention Module as (c). UAFM first uses spatial or channel attention modules to produce the weight «, and then fuses the input features with Mul and Add operation.

FIG. 11 illustrates a Simple Pyramid Pooling Module (SPPM). Conv denotes convolution, batch norm and relu operations. The bin sizes of global-average-pooling are 1×1, 2×2 and 4×4 respectively.

FIG. 12 illustrates the qualitative comparison on the Cityscapes validation set. (a)-(e) represent the predicted image of baseline, baseline+FLD, baseline+FLD+SPPM, baseline+FLD+UAFM and baseline+FLD+SPPM+UAFM respectively, (f) denotes the ground truth.

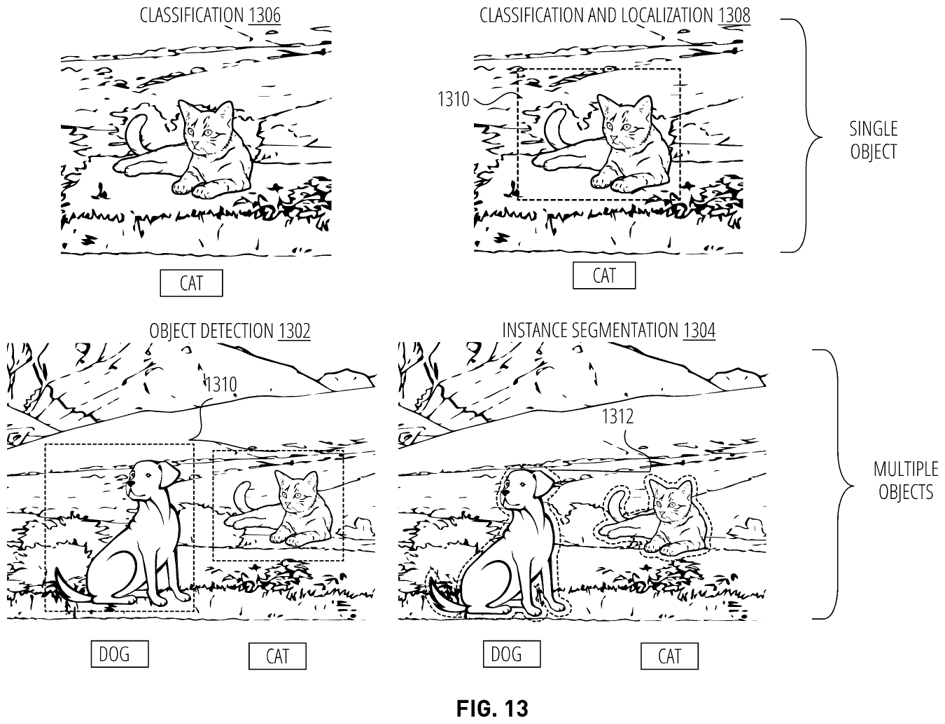

In an embodiment, the image recognition model and the machine learning model may implement aspects of the image recognition and detection models discussed in FIG. 13 through FIG. 16.

FIG. 13 illustrates a comparison between image classification, object detection, and instance segmentation. When a single object is in an image, the classification model 1306 maybe utilized to identify what is in the image. For instance, the classification model 1306 identifies that a cat is in the image. In addition to the classification model 1306, a classification and localization model 1308 may be utilized to classify and identify the location of the cat within the image with a bounding box 1310. When multiple objects are present within an image, an object detection model 1302 may be utilized. The object detection model 1302 utilizes bounding boxes to classify and locate the position of the different objects within the image. An instance segmentation model 1304 detects each object of an image, its localization and its precise segmentation by pixel with a segmentation region 1312.

The Image classification models classify images into a single category, usually corresponding to the most salient object. Photos and videos are usually complex and contain multiple objects. This being said, assigning a label with image classification models may become tricky and uncertain. Object detection models are therefore more appropriate to identify multiple relevant objects in a single image. The second significant advantage of object detection models versus image classification ones is that localization of the objects may be provided.

Some of the model that may be utilized to perform image classification, object detection, and instance segmentation include but are not limited to, Region-based Convolutional Network (R-CNN), Fast Region-based Convolutional Network (Fast R-CNN), Faster Region-based Convolutional Network (Faster R-CNN), Region-based Fully Convolutional Network (R-FCN), You Only Look Once (YOLO), Single-Shot Detector (SSD), Neural Architecture Search Net (NASNet), and Mask Region-based Convolutional Network (Mask R-CNN).

These models may utilize a variety of training datasets that include but are not limited to PASCAL Visual Object Classification (PASCAL VOC) and Common Objects in Context (COCO) datasets.

The PASCAL Visual Object Classification (PASCAL VOC) dataset is a well-known dataset for object detection, classification, segmentation of objects and so on. There are around 10 000 images for training and validation containing bounding boxes with objects. Although, the PASCAL VOC dataset contains only 20 categories, it is still considered as a reference dataset in the object detection problem.

ImageNet has released an object detection dataset since 2013 with bounding boxes. The training dataset is composed of around 500 000 images only for training and 200 categories.

The Common Objects in Context (COCO) datasets were developed by Microsoft. This dataset is used for caption generation, object detection, key point detection and object segmentation. The COCO object detection consists in localizing the objects in an image with bounding boxes and categorizing each one of them between 80 categories.

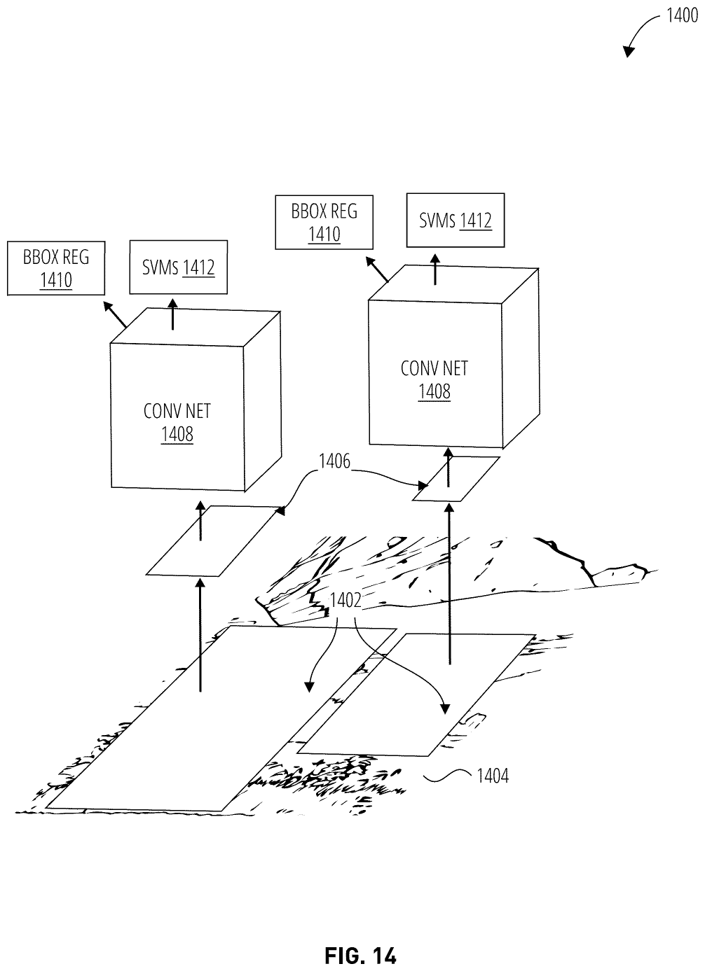

FIG. 14 illustrates an example of a Region-based Convolution Network 1400 (R-CNN). Each region proposal feeds a convolutional neural network (CNN) to extract a features vector, possible objects are detected using multiple SVM classifiers and a linear regressor modifies the coordinates of the bounding box. The regions of interest (ROI 1402) of the input image 1404. Each ROI 1402 of resized/warped creating the warped image region 1406 which are forwarded to the convolutional neural network 1408 where they are feed to the support vector machines 1412 and bounding box linear regressors 1410.

In R-CNN, the selective search method is an alternative to exhaustive search in an image to capture object location. It initializes small regions in an image and merges them with a hierarchical grouping. Thus the final group is a box containing the entire image. The detected regions are merged according to a variety of color spaces and similarity metrics. The output is a small number of region proposals which could contain an object by merging small regions.

The R-CNN model combines the selective search method to detect region proposals and deep learning to find out the object in these regions. Each region proposal is resized to match the input of a CNN from which the method extracts a 4096-dimension vector of features. The features vector is fed into multiple classifiers to produce probabilities to belong to each class. Each one of these classes has a support vector machines 1412 (SVM) classifier trained to infer a probability to detect this object for a given vector of features. This vector also feeds a linear regressor to adapt the shapes of the bounding box for a region proposal and thus reduce localization errors.

The CNN model described is trained on the ImageNet dataset. It is fine-tuned using the region proposals corresponding to an IoU greater than 0.5 with the ground-truth boxes. Two versions are produced, one version is using the PASCAL VOC dataset and the other the ImageNet dataset with bounding boxes. The SVM classifiers are also trained for each class of each dataset.

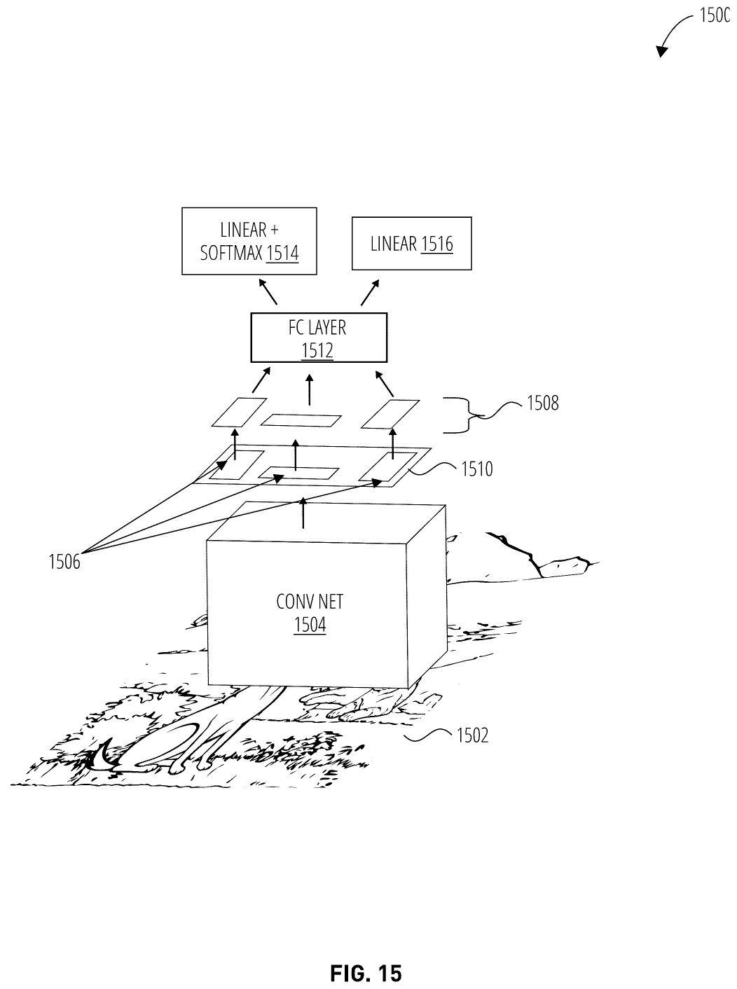

FIG. 15 illustrates an example of a Fast Region-based Convolutional Network 1500 (Fast R-CNN). The entire image (input image 1502) feeds a CNN model (convolutional neural network 1504) to detect RoI (ROI 1506) on the feature maps 1510. Each region is separated using a RoI pooling layer (ROI pooling layer 1508) and it feeds fully connected layers 1512. This vector is used by a softmax classifier 1514 to detect the object and by a bounding box linear regressors 1516 to modify the coordinates of the bounding box. The purpose of the Fast R-CNN is to reduce the time consumption related to the high number of models necessary to analyze all region proposals.

A main CNN with multiple convolutional layers is taking the entire image as input instead of using a CNN for each region proposals (R-CNN). Region of Interests (RoIs) are detected with the selective search method applied on the produced feature maps. Formally, the feature maps size is reduced using a RoI pooling layer to get valid Region of Interests with fixed height and width as hyperparameters. Each RoI layer feeds fully-connected layers creating a features vector. The vector is used to predict the observed object with a softmax classifier and to adapt bounding box localizations with a linear regressor.

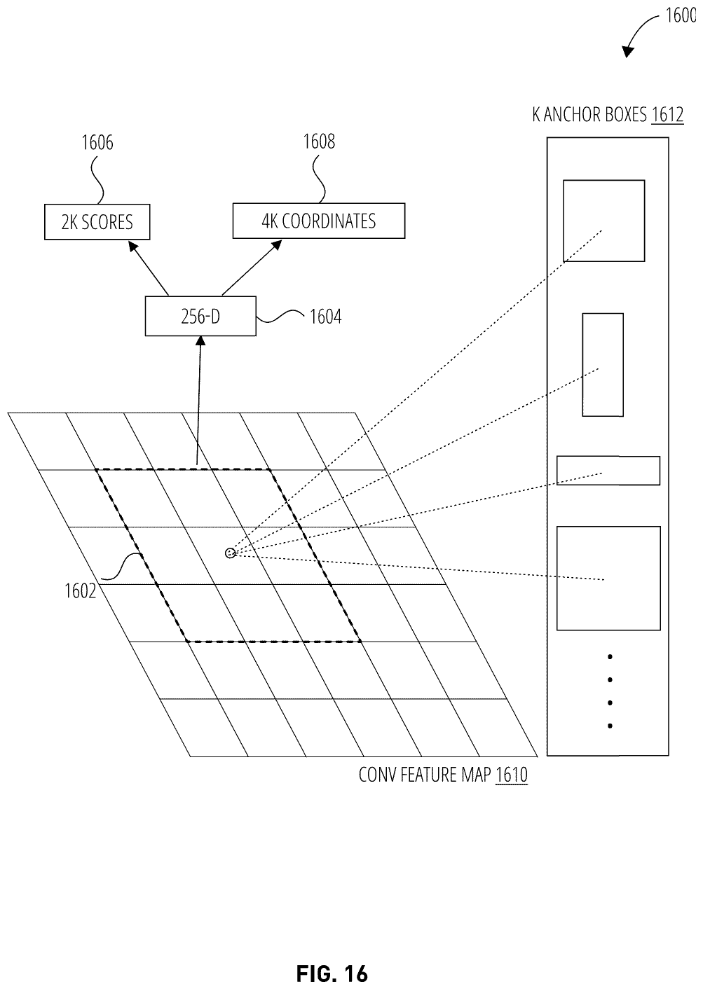

FIG. 16 illustrates an example of a Faster Region-based Convolutional Network 1600 (Faster R-CNN).

Region proposals detected with the selective search method were still necessary in the previous model, which is computationally expensive. Region Proposal Network (RPN) was introduced to directly generate region proposals, predict bounding boxes and detect objects. The Faster R-CNN is a combination between the RPN and the Fast R-CNN model.

A CNN model takes as input the entire image and produces feature map 1610. A window of size 3×3 (sliding window 1602) slides all the feature maps and outputs a features vector (intermediate layer 1604) linked to two fully-connected layers, one for box-regression and one for box-classification. Multiple region proposals are predicted by the fully-connected layers. A maximum of k regions is fixed thus the output of the box regression layer 1608 has a size of 4 k (coordinates of the boxes, their height and width) and the output of the box classification layer 1606 a size of 2 k (“objectness” scores to detect an object or not in the box). The k region proposals detected by the sliding window are called anchors.

When the anchor boxes 1612 are detected, they are selected by applying a threshold over the “objectness” score to keep only the relevant boxes. These anchor boxes and the feature maps computed by the initial CNN model feeds a Fast R-CNN model.

The entire image feeds a CNN model to produce anchor boxes as region proposals with a confidence to contain an object. A Fast R-CNN is used taking as inputs the feature maps and the region proposals. For each box, it produces probabilities to detect each object and correction over the location of the box.

Faster R-CNN uses RPN to avoid the selective search method, it accelerates the training and testing processes and improves the performance. The RPN uses a pre-trained model over the ImageNet dataset for classification and it is fine-tuned on the PASCAL VOC dataset. Then the generated region proposals with anchor boxes are used to train the Fast R-CNN. This process is iterative.

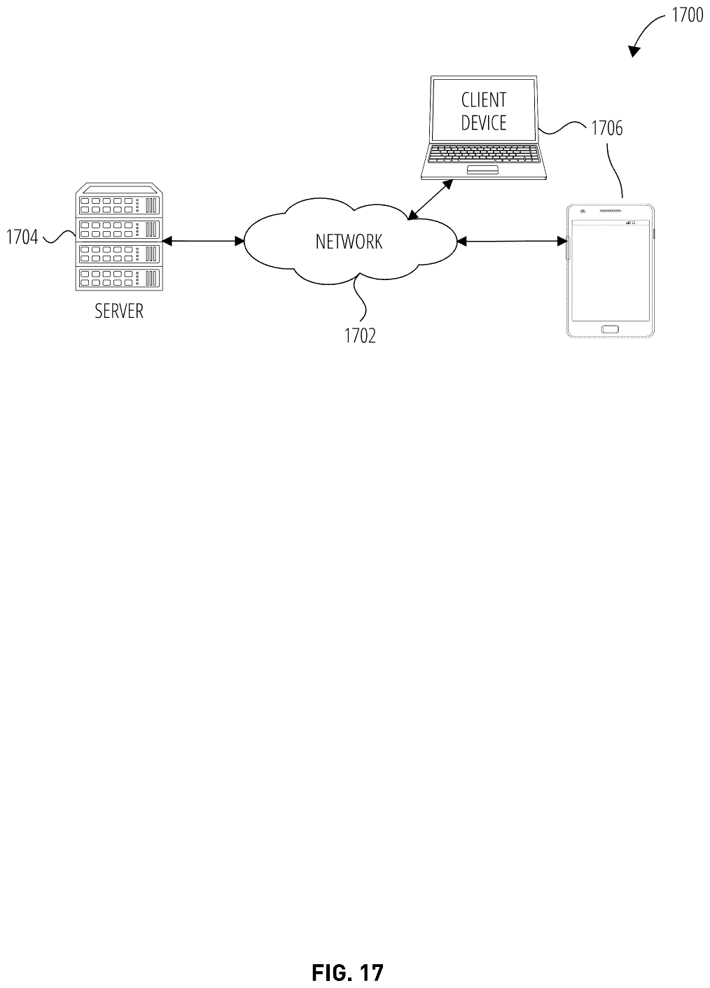

FIG. 17 illustrates a system 1700 in which a server 1704 and a client device 1706 are connected to a network 1702.

In various embodiments, the network 1702 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, the network 1702 may also include a voice network that conveys not only voice communications, but also non-voice data such as Short Message Service (“SMS”) messages, as well as data communicated via various cellular data communication protocols, and the like.

In various embodiments, the client device 1706 may include desktop PCs, mobile phones, laptops, tablets, wearable computers, or other computing devices that are capable of connecting to the network 1702 and communicating with the server 1704, such as described herein.

In various embodiments, additional infrastructure (e.g., short message service centers, cell sites, routers, gateways, firewalls, and the like), as well as additional devices may be present. Further, in some embodiments, the functions described as being provided by some or all of the server 1704 and the client device 1706 may be implemented via various combinations of physical and/or logical devices. However, it is not necessary to show such infrastructure and implementation details in FIG. 17 in order to describe an illustrative embodiment.

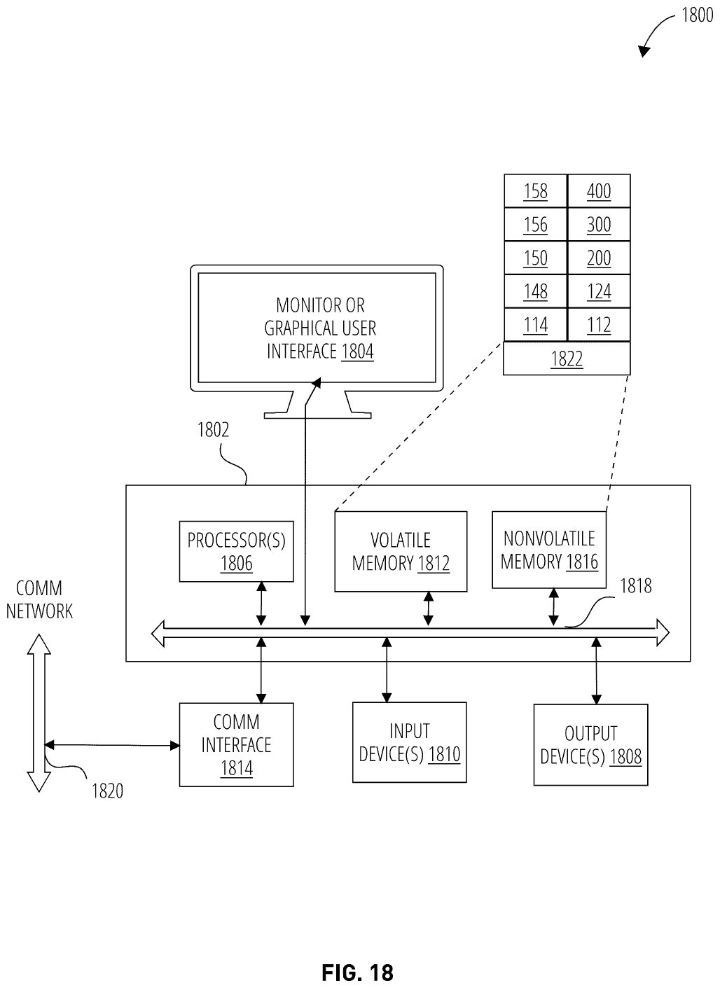

FIG. 18 is an example block diagram of a computing device 1800 that may incorporate embodiments of the present invention. FIG. 18 is merely illustrative of a machine system to carry out aspects of the technical processes described herein, and does not limit the scope of the claims. One of ordinary skill in the art would recognize other variations, modifications, and alternatives. In one embodiment, the computing device 1800 typically includes a monitor or graphical user interface 1804, a data processing system 1802, a communication network interface 1814, input device(s) 1810, output device(s) 1808, and the like.

As depicted in FIG. 18, the data processing system 1802 may include one or more processor(s) 1806 that communicate with a number of peripheral devices via a bus subsystem 1818. These peripheral devices may include input device(s) 1810, output device(s) 1808, communication network interface 1814, and a storage subsystem, such as a volatile memory 1812 and a nonvolatile memory 1816.

The volatile memory 1812 and/or the nonvolatile memory 1816 may store computer-executable instructions and thus forming logic 1822 that when applied to and executed by the processor(s) 1806 implement embodiments of the processes disclosed herein. In an embodiment, the logic may include the normalizer 112, the event handler 114, the image recognition model 124, the curation system 148, the user interface 150, the aggregator 156, the machine learning model 158, the method 200, the method 300, and the method 400.

The input device(s) 1810 include devices and mechanisms for inputting information to the data processing system 1802. These may include a keyboard, a keypad, a touch screen incorporated into the monitor or graphical user interface 1804, audio input devices such as voice recognition systems, microphones, and other types of input devices. In various embodiments, the input device(s) 1810 may be embodied as a computer mouse, a trackball, a track pad, a joystick, wireless remote, drawing tablet, voice command system, eye tracking system, and the like. The input device(s) 1810 typically allow a user to select objects, icons, control areas, text and the like that appear on the monitor or graphical user interface 1804 via a command such as a click of a button or the like.

The output device(s) 1808 include devices and mechanisms for outputting information from the data processing system 1802. These may include the monitor or graphical user interface 1804, speakers, printers, infrared LEDs, and so on as well understood in the art.

The communication network interface 1814 provides an interface to communication networks (e.g., communication network 1820) and devices external to the data processing system 1802. The communication network interface 1814 may serve as an interface for receiving data from and transmitting data to other systems. Embodiments of the communication network interface 1814 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 1814 may be coupled to the communication network 1820 via an antenna, a cable, or the like. In some embodiments, the communication network interface 1814 may be physically integrated on a circuit board of the data processing system 1802, or in some cases may be implemented in software or firmware, such as “soft modems”, or the like.

The computing device 1800 may include logic that enables communications over a network using protocols such as HTTP, TCP/IP, RTP/RTSP, IPX, UDP and the like.

The volatile memory 1812 and the nonvolatile memory 1816 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1812 and the nonvolatile memory 1816 may be configured to store the basic programming and data constructs that provide the functionality of the disclosed processes and other embodiments thereof that fall within the scope of the present invention.

Logic 1822 that implements embodiments of the present invention may be stored in the volatile memory 1812 and/or the nonvolatile memory 1816. Said logic 1822 may be read from the volatile memory 1812 and/or nonvolatile memory 1816 and executed by the processor(s) 1806. The volatile memory 1812 and the nonvolatile memory 1816 may also provide a repository for storing data used by the logic 1822.

The volatile memory 1812 and the nonvolatile memory 1816 may include a number of memories including a main random access memory (RAM) for storage of instructions and data during program execution and a read only memory (ROM) in which read-only non-transitory instructions are stored. The volatile memory 1812 and the nonvolatile memory 1816 may include a file storage subsystem providing persistent (non-volatile) storage for program and data files. The volatile memory 1812 and the nonvolatile memory 1816 may include removable storage systems, such as removable flash memory.

The bus subsystem 1818 provides a mechanism for enabling the various components and subsystems of data processing system 1802 to communicate with each other as intended. Although the communication network interface 1814 is depicted schematically as a single bus, some embodiments of the bus subsystem 1818 may utilize multiple distinct busses.

It will be readily apparent to one of ordinary skill in the art that the computing device 1800 may be a device such as a smartphone, a desktop computer, a laptop computer, a rack-mounted computer system, a computer server, or a tablet computer device. As commonly known in the art, the computing device 1800 may be implemented as a collection of multiple networked computing devices. Further, the computing device 1800 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine-readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “heroin,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

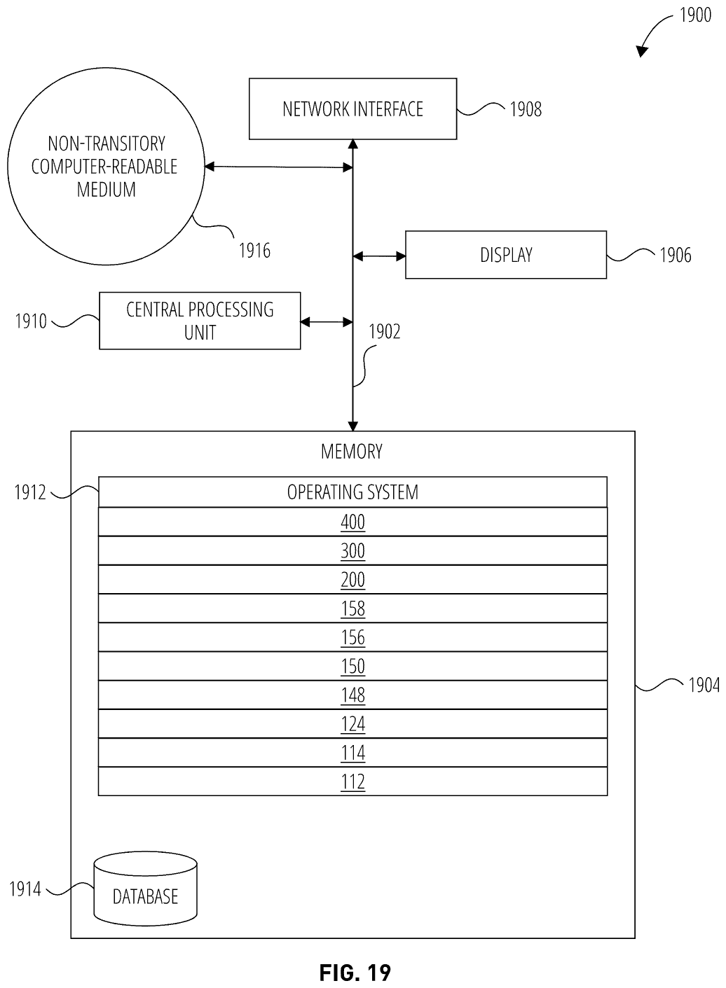

FIG. 19 illustrates several components of an exemplary system 1900 in accordance with one embodiment. In various embodiments, system 1900 may include a desktop PC, server, workstation, mobile phone, laptop, tablet, set-top box, appliance, or other computing device that is capable of performing operations such as those described herein. In some embodiments, system 1900 may include many more components than those shown in FIG. 19. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 1900 may comprise one or more physical and/or logical devices that collectively provide the functionalities described herein. In some embodiments, system 1900 may comprise one or more replicated and/or distributed physical or logical devices.

In some embodiments, system 1900 may comprise one or more computing resources provisioned from a “cloud computing” provider, for example, Amazon Elastic Compute Cloud (“Amazon EC2”), provided by Amazon.com, Inc. of Seattle, Washington; Sun Cloud Compute Utility, provided by Sun Microsystems, Inc. of Santa Clara, California; Windows Azure, provided by Microsoft Corporation of Redmond, Washington, and the like.

System 1900 includes a bus 1902 interconnecting several components including a network interface 1908, a display 1906, a central processing unit 1910, and a memory 1904.

Memory 1904 generally comprises a random access memory (“RAM”) and a permanent non-transitory mass storage device, such as a hard disk drive or solid-state drive. Memory 1904 stores an operating system 1912.

These and other software components may be loaded into memory 1904 of system 1900 using a drive mechanism (not shown) associated with a non-transitory computer-readable 1916, such as a DVD/CD-ROM drive, memory card, network download, or the like.

Memory 1904 also includes database 1914. In some embodiments, system 1900 may communicate with database 1914 via network interface 1908, a storage area network (“SAN”), a high-speed serial bus, and/or via other suitable communication technology. In an embodiment, memory 1904 may include the normalizer 112, the event handler 114, the image recognition model 124, the curation system 148, the user interface 150, the aggregator 156, the machine learning model 158, the method 200, the method 300, and the method 400.

In some embodiments, database 1914 may comprise one or more storage resources provisioned from a “cloud storage” provider, for example, Amazon Simple Storage Service (“Amazon S3”), provided by Amazon.com, Inc. of Seattle, Washington, Google Cloud Storage, provided by Google, Inc. of Mountain View, California, and the like. The database 1914 may include cloud storage 146, the streaming database 138, and the relational database 140.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine-readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

### Region-Based Fully Convolutional Network (R-FCN)

Fast and Faster R-CNN methodologies consist of detecting region proposals and recognizing an object in each region. The Region-based Fully Convolutional Network (R-FCN) is a model with only convolutional layers allowing complete backpropagation for training and inference. The method merged the two basic steps in a single model to take into account simultaneously the object detection (location invariant) and its position (location variant).

A ResNet-101 model takes the initial image as input. The last layer outputs feature maps, each one is specialized in the detection of a category at some location. For example, one feature map is specialized in the detection of a cat, another one in a banana and so on. Such feature maps are called position-sensitive score maps because they take into account the spatial localization of a particular object. It consists of k*k*(C+1) score maps where k is the size of the score map, and C the number of classes. All these maps form the score bank. Basically, we create patches that can recognize part of an object. For example, for k=3, we can recognize 3×3 parts of an object.

In parallel, the method runs a RPN to generate Region of Interest (RoI). Finally, the method cuts each RoI in bins and checks them against the score bank. If enough of these parts are activated, then the patch vote ‘yes’, I recognized the object.

### You Only Look Once (YOLO)

The YOLO model directly predicts bounding boxes and class probabilities with a single network in a single evaluation. The simplicity of the YOLO model allows real-time predictions.

Initially, the model takes an image as input. It divides it into an S×S grid. Each cell of this grid predicts B bounding boxes with a confidence score. This confidence is simply the probability to detect the object multiply by the IoU between the predicted and the ground truth boxes.

The CNN used is inspired by the GoogLeNet model introducing the inception modules. The network has 24 convolutional layers followed by 2 fully-connected layers. Reduction layers with 1×1 filters⁴ followed by 3×3 convolutional layers replace the initial inception modules. The Fast YOLO model is a lighter version with only 9 convolutional layers and fewer number of filters. Most of the convolutional layers are pretrained using the ImageNet dataset with classification. Four convolutional layers followed by two fully-connected layers are added to the previous network and it is entirely retrained with the PASCAL VOC datasets.

The final layer outputs a S*S*(C+B*5) tensor corresponding to the predictions for each cell of the grid. C is the number of estimated probabilities for each class. B is the fixed number of anchor boxes per cell, each of these boxes being related to 4 coordinates (coordinates of the center of the box, width and height) and a confidence value.

With the previous models, the predicted bounding boxes often contained an object. The YOLO model however predicts a high number of bounding boxes. Thus there are a lot of bounding boxes without any object. The Non-Maximum Suppression (NMS) method is applied at the end of the network. It consists in merging highly-overlapping bounding boxes of a same object into a single one.

### Single-Shot Detector (SSD)

A Single-Shot Detector (SSD) model predicts all at once the bounding boxes and the class probabilities with an end-to-end CNN architecture.

The model takes an image as the input which passes through multiple convolutional layers with different sizes of filter (10×10, 5×5 and 3×3). Feature maps from convolutional layers at different position of the network are used to predict the bounding boxes. They are processed by a specific convolutional layers with 3×3 filters called extra feature layers to produce a set of bounding boxes similar to the anchor boxes of the Fast R-CNN.

Each box has 4 parameters: the coordinates of the center, the width and the height. At the same time, it produces a vector of probabilities corresponding to the confidence over each class of object.

The Non-Maximum Suppression method is also used at the end of the SSD model to keep the most relevant bounding boxes. The Hard Negative Mining (HNM) is then used because a lot of negative boxes are still predicted. It consists in selecting only a subpart of these boxes during the training. The boxes are ordered by confidence and the top is selected depending on the ratio between the negative and the positive which is at most ⅓.

### Neural Architecture Search Net (NASNet)

The Neural Architecture Search consists of learning the architecture of a model to optimize the number of layers while improving the accuracy over a given dataset.

The NASNet network has an architecture learned from the CIFAR-10 dataset and is trained with the ImageNet dataset. This model is used for feature maps generation and is stacked into the Faster R-CNN pipeline. Then the entire pipeline is retrained with the COCO dataset.

### Mask Region-Based Convolutional Network (Mask R-CNN)

Another extension of the Faster R-CNN model adds a parallel branch to the bounding box detection in order to predict object mask. The mask of an object is its segmentation by pixel in an image. This model outperforms the state-of-the-art in the four COCO challenges: the instance segmentation, the bounding box detection, the object detection and the key point detection.

The Mask Region-based Convolutional Network (Mask R-CNN) uses the Faster R-CNN pipeline with three output branches for each candidate object: a class label, a bounding box offset and the object mask. It uses Region Proposal Network (RPN) to generate bounding box proposals and produces the three outputs at the same time for each Region of Interest (RoI).

The initial RoIPool layer used in the Faster R-CNN is replaced by a RoIAlign layer. It removes the quantization of the coordinates of the original RoI and computes the exact values of the locations. The RoIAlign layer provides scale-equivariance and translation-equivariance with the region proposals.

The model takes an image as input and feeds a ResNeXt network with 101 layers. This model looks like a ResNet but each residual block is cut into lighter transformations which are aggregated to add sparsity in the block. The model detects RoIs which are processed using a RoIAlign layer. One branch of the network is linked to a fully-connected layer to compute the coordinates of the bounding boxes and the probabilities associated to the objects. The other branch is linked to two convolutional layers, the last one computes the mask of the detected object.

Three loss functions associated to each task to solve are summed. This sum is minimized and produces great performances because solving the segmentation task improve the localization and thus the classification.

What is claimed is:

1. A method comprising:
detecting a trigger event during operation of an autonomous ground vehicle traveling between two physical locations, wherein the autonomous ground vehicle comprises primary sensors, secondary sensors, a location module, a navigational control system, a communication module, and movement systems;
generating event sequence data from primary sensor data, secondary sensor data, spatiotemporal data, and telemetry data through operation of a reporter;
communicating the event sequence data to cloud storage and raw data to a streaming database;
transforming the raw data into normalized data stored in a relational database through operation of a normalizer;
operating a curation system to identify true trigger events from the normalized data and extract training data by way of a discriminator;
operating a machine learning model within an active learning pipeline to generate a model update from aggregate training data generated from the training data by an aggregator; and
reconfiguring the navigational control system with the model update communicated from the active learning pipeline to the autonomous ground vehicle.

2. The method of claim 1 further comprises:
configuring an event handler with event triggers;
operating the navigational control system comprising an image recognition model, a controller, and the event handler, to receive:
the primary sensor data from the primary sensors;
the spatiotemporal data from the location module;
the secondary sensor data from the secondary sensors; and
the telemetry data from the movement systems;
controlling the movement systems through operation of the controller and the image recognition model to transport the autonomous ground vehicle between two physical locations;
communicating the raw data comprising the primary sensor data, the secondary sensor data, the spatiotemporal data, and the telemetry data to the streaming database by way of the communication module; and
operating the event handler to monitor the primary sensor data, the secondary sensor data, the spatiotemporal data, and the telemetry data for the event triggers.

3. The method of claim 1 further comprises:
configuring the normalizer with the event sequence data to transform the raw data into the normalized data.

4. The method of claim 1 further comprises:
communicating the raw data to the curation system from the streaming database;
operating the discriminator to identify at least one trigger event in the raw data; and
triggering the reporter to generate the event sequence data.

5. The method of claim 1, wherein the training data comprises image data collected by the primary sensors during operation of the autonomous ground vehicle during the trigger event.

6. The method of claim 1, wherein the discriminator is configured by way of a user interface to identify the true trigger events from false positives.

7. The method of claim 1, wherein the machine learning model and the image recognition model are semantic segmentation models.

8. A computing apparatus comprising:
a processor; and
a memory storing instructions that, when executed by the processor, configure the apparatus to:
detect a trigger event during operation of an autonomous ground vehicle traveling between two physical locations, wherein the autonomous ground vehicle comprises primary sensors, secondary sensors, a location module, a navigational control system, a communication module, and movement systems;
generate event sequence data from primary sensor data, secondary sensor data, spatiotemporal data, and telemetry data through operation of a reporter;
communicate the event sequence data to cloud storage and raw data to a streaming database;
transform the raw data into normalized data stored in a relational database through operation of a normalizer;
operate a curation system to identify true trigger events from the normalized data and extract training data by way of a discriminator;
operate a machine learning model within an active learning pipeline to generate a model update from aggregate training data generated from the training data by an aggregator; and
reconfigure the navigational control system with the model update communicated from the active learning pipeline to the autonomous ground vehicle.

9. The computing apparatus of claim 8 further comprises:
configure an event handler with event triggers;
operate the navigational control system comprising an image recognition model, a controller, and the event handler, to receive:
the primary sensor data from the primary sensors;
the spatiotemporal data from the location module;
the secondary sensor data from the secondary sensors; and
the telemetry data from the movement systems;
control the movement systems through operation of the controller and the image recognition model to transport the autonomous ground vehicle between two physical locations;
communicate the raw data comprising the primary sensor data, the secondary sensor data, the spatiotemporal data, and the telemetry data to the streaming database by way of the communication module; and
operate the event handler to monitor the primary sensor data, the secondary sensor data, the spatiotemporal data, and the telemetry data for the event triggers.

10. The computing apparatus of claim 8 further comprises:
configure the normalizer with the event sequence data to transform the raw data into the normalized data.

11. The computing apparatus of claim 8, wherein the training data comprises image data collected by the primary sensors during operation of the autonomous ground vehicle during the trigger event.

12. The computing apparatus of claim 8, wherein the discriminator is configured by way of a user interface to identify the true trigger events from false positives.

13. The computing apparatus of claim 8, wherein the machine learning model and the image recognition model are semantic segmentation models.

14. A non-transitory computer-readable storage medium, the computer-readable storage medium including instructions that when executed by a computer, cause the computer to:
detect a trigger event during operation of an autonomous ground vehicle traveling between two physical locations, wherein the autonomous ground vehicle comprises primary sensors, secondary sensors, a location module, a navigational control system, a communication module, and movement systems;
generate event sequence data from primary sensor data, secondary sensor data, spatiotemporal data, and telemetry data through operation of a reporter;
communicate the event sequence data to cloud storage and raw data to a streaming database;
transform the raw data into normalized data stored in a relational database through operation of a normalizer;
operate a curation system to identify true trigger events from the normalized data and extract training data by way of a discriminator;
operate a machine learning model within an active learning pipeline to generate a model update from aggregate training data generated from the training data by an aggregator; and
reconfigure the navigational control system with the model update communicated from the active learning pipeline to the autonomous ground vehicle.

15. The computer-readable storage medium of claim 14 further comprises:
configure an event handler with event triggers;
operate the navigational control system comprising an image recognition model, a controller, and the event handler, to receive:
the primary sensor data from the primary sensors;
the spatiotemporal data from the location module;
the secondary sensor data from the secondary sensors; and
the telemetry data from the movement systems;
control the movement systems through operation of the controller and the image recognition model to transport the autonomous ground vehicle between two physical locations;
communicate the raw data comprising the primary sensor data, the secondary sensor data, the spatiotemporal data, and the telemetry data to the streaming database by way of the communication module; and
operate the event handler to monitor the primary sensor data, the secondary sensor data, the spatiotemporal data, and the telemetry data for the event triggers.

16. The non-transitory computer-readable storage medium of claim 14 further comprises:
configure the normalizer with the event sequence data to transform the raw data into the normalized data.

17. The non-transitory computer-readable storage medium of claim 14 further comprises:
communicate the raw data to the curation system from the streaming database;
operate the discriminator to identify at least one trigger event in the raw data; and
trigger the reporter to generate the event sequence data.

18. The non-transitory computer-readable storage medium of claim 14, wherein the training data comprises image data collected by the primary sensors during operation of the autonomous ground vehicle during the trigger event.

19. The non-transitory computer-readable storage medium of claim 14, wherein the discriminator is configured by way of a user interface to identify the true trigger events from false positives.

20. The non-transitory computer-readable storage medium of claim 14, wherein the machine learning model and the image recognition model are semantic segmentation models.
